(19) United States
(12) Patent Application Publication
(10) Pub. No.: US 2022/0238109 A1
(43) Pub. Date: Jul. 28, 2022

(54) INFORMATION PROCESSOR AND INFORMATION PROCESSING METHOD

(71) Applicant: Sony Group Corporation, Tokyo (JP)

(72) Inventors: Remu HIDA, Tokyo (JP); Saya KANNO, Tokyo (JP); Chiaki MIYAZAKI, Tokyo (JP); Masanori INOUE, Tokyo (JP)

(73) Assignee: Sony Group Corporation, Tokyo (JP)

(21) Appl. No.: 17/617,017

(22) PCT Filed: Apr. 30, 2020
(86) PCT No.: PCT/JP2020/018358

§ 371 Date: Dec. 7, 2021

(30) Foreign Application Priority Data
Jun. 14, 2019 (JP) 2019-111532

(51) Int. Cl. G10L 15/22; G06F 3/16; G06F 16/9032

(52) U.S. Cl. CPC G10L 15/22; G06F 3/16; G10L 2015/225; G10L 2015/221; G10L 2015/223; G06F 16/90332

(57) ABSTRACT

An information processor according to the present disclosure includes an acquisition unit that acquires first information serving as a trigger for interaction, second information indicating an answer to the first information, and third information indicating a response to the second information; and a collection unit that collects a combination of the first information, the second information, and the third information acquired by the acquisition unit.

### FIELD

The present disclosure relates to an information processor and an information processing method.

### BACKGROUND

Conventionally, an interactive agent system (interaction system) that interacts with a user has been known. For example, a technology for collecting input information associated with a specific answer subject and answer information to the input information has been provided.

### CITATION LIST

### Patent Literature

Patent Literature 1: JP 2011-103063 A

### SUMMARY

### Technical Problem

According to the related art, input information associated with an answer subject and answer information to the input information are collected.

However, it is not always possible to realize a natural flow of conversation using the data collected in the related art. For example, in the related art, the conversation is designed using a set of two pieces of information, i.e., the input information associated with the answer subject and the answer information to the input information. In other words, the conversation is designed using a set of certain information and an answer to the certain information. Thus, it is not possible to consider a flow of interaction beyond a question and answer pair. As described above, it is difficult to construct an interaction system to perform an appropriate conversation only by using a set of two pieces of information, i.e., certain information and a response to the certain information.

Therefore, the present disclosure proposes an information processor and an information processing method capable of acquiring information for constructing the interaction system.

### Solution to Problem

According to the present disclosure, an information processing device includes an acquisition unit that acquires first information serving as a trigger for interaction, second information indicating an answer to the first information, and third information indicating a response to the second information; and a collection unit that collects a combination of the first information, the second information, and the third information acquired by the acquisition unit.

### BRIEF DESCRIPTION OF DRAWINGS

FIG. 1 is a diagram illustrating an example of information processing according to an embodiment of the present disclosure.

FIG. 2 is a diagram illustrating a configuration example of an information processing system according to the embodiment of the present disclosure.

FIG. 3 is a diagram illustrating a configuration example of an information processor according to the embodiment of the present disclosure.

FIG. 4 is a diagram illustrating an example of a first information storage unit according to the embodiment of the present disclosure.

FIG. 5 is a diagram illustrating an example of a combination information storage unit according to the embodiment of the present disclosure.

FIG. 6 is a diagram illustrating an example of a connection information storage unit according to the embodiment of the present disclosure.

FIG. 7 is a diagram illustrating an example of a scenario information storage unit according to the embodiment of the present disclosure.

FIG. 8 is a diagram illustrating an example of a model information storage unit according to the embodiment of the present disclosure.

FIG. 9 is a diagram illustrating a configuration example of a terminal device according to the embodiment of the present disclosure.

FIG. 10 is a flowchart illustrating a procedure of information processing according to the embodiment of the present disclosure.

FIG. 11 is a flowchart illustrating the procedure of information processing according to the embodiment of the present disclosure.

FIG. 12 is a flowchart illustrating a scenario generation procedure according to the embodiment of the present disclosure.

FIG. 13 is a diagram illustrating another example of the combination information storage unit.

FIG. 14 is a diagram illustrating an example of generation of scenario information.

FIG. 15 is a diagram illustrating an example of generation of scenario information.

FIG. 16 is a diagram illustrating an example of conversation relation recognition.

FIG. 17 is a diagram illustrating an example of model learning of conjunction estimation.

FIG. 18 is a diagram illustrating an example of model learning of conversation relation recognition.

FIG. 19 is a diagram illustrating an example of model learning of next mini-scenario estimation based on conjunction.

FIG. 20 is a diagram illustrating an example of a network corresponding to a model according to the embodiment of the present disclosure.

FIG. 21 is a diagram illustrating a configuration example of an information processor according to a modification of the present disclosure.

FIG. 22 is a diagram illustrating an example of a combination information storage unit according to the modification of the present disclosure.

FIG. 23 is a diagram illustrating an example of a branch scenario according to the modification.

FIG. 24 is a flowchart illustrating a procedure of interaction processing according to the modification.

FIG. 25 is a diagram illustrating another example of the combination information storage unit.

FIG. 26 is a diagram illustrating an example of use of the interaction system.

FIG. 27 is a diagram illustrating another example of use of the interaction system.

FIG. 28 is a hardware configuration diagram illustrating an example of a computer realizing the information processor or a function of the information processor.

### DESCRIPTION OF EMBODIMENTS

Hereinafter, embodiments of the present disclosure will be described in detail with reference to the drawings. Note that an information processor and an information processing method according to the present disclosure are not limited by the embodiments. In each of the following embodiments, same parts are denoted by same reference signs to omit redundant description.

The present disclosure will be described according to the following order of items.

1. Embodiment

1-1. Overview of information processing according to embodiment of present disclosure

1-1-1. Subject

1-1-2. Input information

1-2. Configuration of information processing system according to embodiment

1-3. Configuration of information processor according to embodiment

1-4. Configuration of terminal device according to embodiment

1-5. Procedure of information processing according to embodiment

1-5-1. Procedure of collection processing according to information processor

1-5-2. Procedure of collection processing according to information processing system

1-5-3. Procedure of generation processing according to information processor

1-6. Storage example of combination (QAC triple)

1-7. Processing using combination (QAC triple)

1-7-1. Scenario information generation

1-7-2. Conversation relation recognition

1-8. Model learning

1-8-1. Model learning of conjunction estimation

1-8-2. Model learning of conversation relation recognition

1-8-3. Model learning of next mini-scenario estimation based on conjunction

1-8-4. Network example

1-9. Configuration of information processor according to modification

1-10. Branch scenario according to modification

1-11. Procedure of information processing according to modification

1-12. Example of use of interaction system

2. Other embodiment

2-1. Other configuration example

2-2. Others

3. Advantageous effects of present disclosure

4. Hardware configuration

### 1. Embodiment

### 1-1. Overview of Information Processing According to Embodiment of Present Disclosure

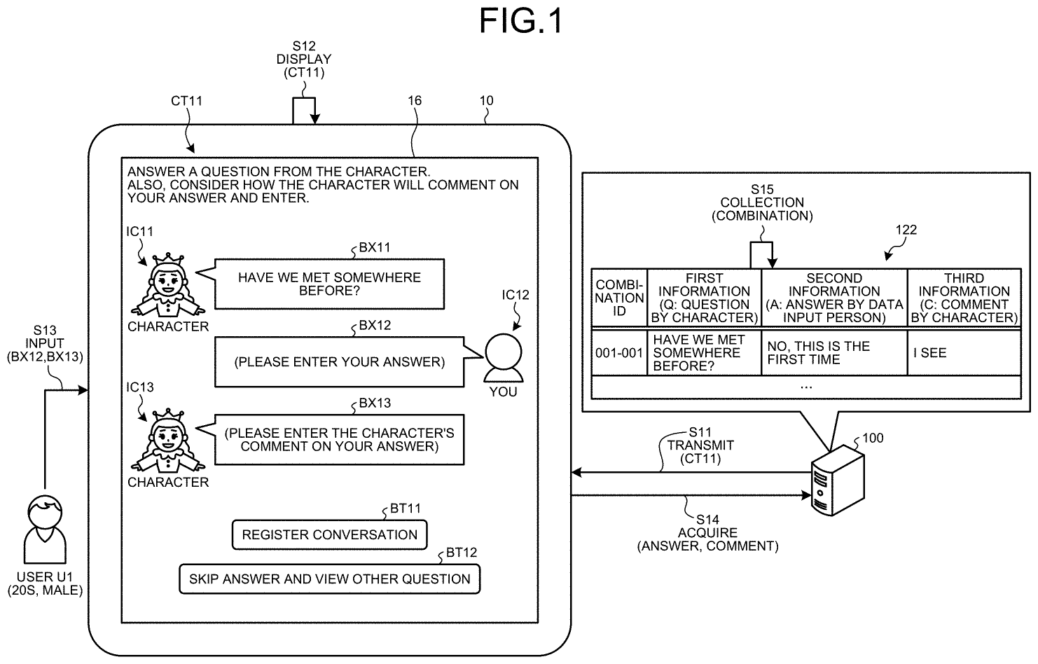

FIG. 1 is a diagram illustrating an example of information processing according to an embodiment of the present disclosure. The information processing according to the embodiment of the present disclosure is realized by an information processor 100 illustrated in FIG. 1.

The information processor 100 is an information processor that executes information processing according to the embodiment. The information processor 100 collects a combination of first information serving as a trigger for interaction, second information indicating an answer to the first information, and third information indicating a response to the second information. In the example in FIG. 1, a question from a character in an interaction system (a computer system capable of having a conversation with a human) to a user is illustrated as an example of the first information serving as the trigger for interaction. Furthermore, in the example in FIG. 1, an answer (also referred to as “reply”) by the user to the question is illustrated as an example of the second information, and a response (also referred to as “comment” or “reply”) by the character of the interaction system to the user's reply is illustrated as an example of the third information. In this manner, in the example in FIG. 1, the information processor 100 collects a combination of the first information that is a question (Q) serving as the trigger for interaction, the second information that is an answer (A) to the question (Q), and the third information that is a comment (C) to the answer (A) (also referred to as a “QAC triple”).

Note that the first information, the second information, and the third information illustrated in FIG. 1 are examples. For example, the first information is not limited to a question, and may be any information as long as the information prompts a response by the user. The first information may be any information as long as the information serves as a trigger for interaction, for example, utterance that will prompt the user's response. In other words, the trigger for interaction mentioned here is not limited to direct prompting of a response of another subject, such as a question. The trigger can also be a monologue, murmur, or the like that is not directed to another subject. A concept of trigger includes various manners that can attract attention (interest) of another subject to cause a response by another subject. Furthermore, a subject who asks the question to the user or respond to the answer by the user is not limited to a specific character. The subject may be a different character in the interaction system. This will be described later.

The example in FIG. 1 illustrates an example in which the information processor 100 collects the QAC triple by presenting the question (Q) to a user U1 and prompting the user U1 to input the answer (A) to the question (Q) and the comment (C). As described above, FIG. 1 illustrates the example in which the QAC triple is collected by prompting one user to input the answer (A) to the question (Q) prepared in advance in the information processor 100 and the comment (C). However, the question (Q) may be input by the user, or the question (Q), the answer (A), and the comment (C) may be input by different users. This will be detailed later.

First, in the example in FIG. 1, the information processor 100 transmits content CT11, which is a QAC triple collection screen including a question, to a terminal device 10 used by the user U1 (Step S11). The content CT11 includes a first box BX11 in which the question (Q) from the character is arranged, a second box BX12 in which a form for inputting the answer (A) to the question (Q) is arranged, and a third box BX13 in which a form for inputting the comment (C) by the character on the answer (A) is arranged.

In the first box BX11 in the content CT11, a character string “Have we met somewhere before?” of the question from the character to the user is arranged. The first box BX11 is displayed in a balloon from an icon IC11 corresponding to the character so that the character can be recognized as the utterance subject.

Still more, a character string “(Please enter your answer)” is arranged in the second box BX12 in the content CT11 so that the second box BX12 functions as a form for the user to input an answer to the question. The second box BX12 is displayed in a balloon from an icon IC12 corresponding to the user so that the user can be recognized as the utterance subject.

Furthermore, a character string “(Please enter the character's comment on your answer)” is arranged in the third box BX13 in the content CT11 so that the third box BX13 functions as a form to input the character's comment on the user's answer. The third box BX13 is displayed in a balloon from an icon IC13 corresponding to the character so that the character can be recognized as the utterance subject.

Furthermore, the content CT11 includes a character string such as “Answer a question from the character. Also, consider how the character will comment on your answer and enter”. As a result, the content CT11 prompts the user to input the user's own answer to the question and an expected character's comment on the answer.

In addition, the content CT11 includes a registration button BT11 on which a character string “Register conversation” is indicated. The registration button BT11 is a button for transmitting the input information. For example, when the user presses the registration button BT11 in the content CT11 displayed on the terminal device 10, information or the like input by the user in the content CT11 is transmitted to the information processor 100.

Still more, a button for skipping an answer to the displayed question and displaying another question may be provided. For example, the content CT11 includes a skip button BT12 on which a character string “Skip answer and view other question” is indicated. For example, when the user presses the skip button BT12 in the content CT11 displayed on the terminal device 10, the displayed question is changed to another question. For example, when the user presses the skip button BT12 in a state that the question “Have we met somewhere before?” is displayed, the question is changed from “Have we met somewhere before?” to another question. In this case, for example, the question is changed from “Have we met somewhere before?” to “Where from?”. Furthermore, instead of the skip button BT12, for example, there may be a function of allowing the user to select a specific question.

As described above, the information processor 100 transmits the content CT11 including the question “Have we met somewhere before?” to the terminal device 10 used by the user U1. As a result, the information processor 100 presents the question to the user U1. Note that the information processor 100 may determine a question to be presented to the user by using various types of information. For example, the information processor 100 determines the question to be presented to the user by using, as required, various types of information such as priority of each question and the number of times of presentation. In the example in FIG. 1, the information processor 100 determines “Have we met somewhere before?” that has the smallest first information ID as a question to be presented.

The terminal device 10 that has received the content CT11 displays the content CT11 (Step S12). The terminal device 10 displays the content CT11 on a display unit 16.

Then, the terminal device 10 accepts an input by the user U1 (Step S13). In the example in FIG. 1, the terminal device 10 accepts the input by the user U1 regarding an answer by the user U1 to the question in the content CT11 and a comment by the character on the answer.

The terminal device 10 accepts, in the second box BX12 in the content CT11, an input indicating an answer by the user U1 to the question “Have we met somewhere before?”. In the example in FIG. 1, when the user U1 inputs a character string “No, this is the first time” in the second box BX12, the terminal device 10 accepts the character string “No, this is the first time” as the answer to the question.

In addition, the terminal device 10 accepts, in the third box BX13 in the content CT11, an input indicating a comment by the character on the answer “No, this is the first time” by the user U1. In the example in FIG. 1, when the user U1 inputs the character string “I see” in the third box BX13, the terminal device 10 accepts the character string “I see” as the comment by the character on the answer by the user U1.

Then, in response to the pressing of the registration button BT11 by the user U1, the terminal device 10 transmits to the information processor 100 the information input by the user U1 in the content CT11. In the example in FIG. 1, the terminal device 10 transmits the information indicating the answer “No, this is the first time” and the information indicating the comment “I see” input by the user U1 to the information processor 100. Note that the terminal device 10 may transmit meta-information such as an age and gender of the user U1 to the information processor 100 together with the information input by the user U1 in the content CT11.

Then, the information processor 100 acquires the answer and the comment (Step S14). The information processor 100 acquires the answer and the comment from the terminal device 10. The information processor 100 acquires the second information that is the answer to the question and the third information that is the comment on the answer. The information processor 100 acquires the second information that is the answer input by the user U1 and the third information that is the comment input by the user U1. In the example in FIG. 1, the information processor 100 acquires the information indicating the answer “No, this is the first time” and the information indicating the comment “I see” input by the user U1. Note that the information processor 100 may acquire the information indicating the question presented to the user U1 from the terminal device 10 or the meta information of the user U1 from the terminal device 10.

Then, the information processor 100 collects the combination of the first information serving as the trigger for interaction, the second information indicating the answer to the first information, and the third information indicating the response to the second information (Step S15). The information processor 100 collects the combination (QAC triple) of the first information that is a question (Q) serving as the trigger for interaction, the second information that is the answer (A) to the question (Q), and the third information that is the comment (C) on the answer (A). The information processor 100 stores the combination (QAC triple) of the question (Q) presented to the user U1, and the answer (A) and the comment (C) input by the user U1 in a combination information storage unit 122 to collect the QAC triple. In the example in FIG. 1, the information processor 100 stores a combination of information indicating the question “Have we met somewhere before?”, information indicating the answer “No, this is the first time”, and information indicating the comment “I see” as the QAC triple in the combination information storage unit 122.

As described above, the information processor 100 presents the question (Q) to the user U1 to prompt the user U1 to input the answer (A) and the comment (C), thereby collecting the combination (QAC triple) of the first information (question), the second information (answer), and the third information (response). As a result, the information processor 100 can acquire information for constructing the interaction system.

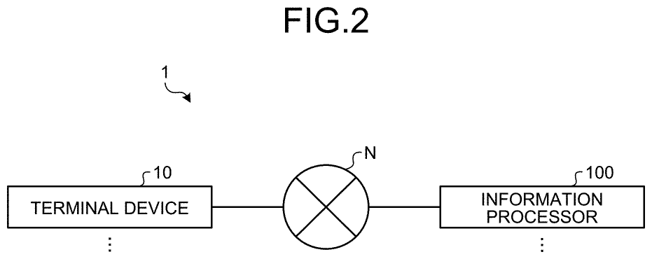

As described above, in an information processing system 1 (see FIG. 2), the user inputs, as the user, the answer (A) to the question (Q) presented by the system (character) imitating a specific character, and then the user inputs the comment (C) assuming how the character will respond to the user's answer. As a result, the information processing system 1 can collect data in units such as the combination (QAC triple) of the first information (question), the second information (answer), and the third information (comment). In other words, the information processor 100 can collect information such as utterance serving as the trigger for interaction, an answer to the utterance, and information on further response to the answer. Therefore, the information processor 100 can reduce a burden required for constructing the interaction system based on the information such as the utterance serving as the trigger for interaction, the answer to the information, and further response to the answer.

In addition, the information processor 100 stores the input meta information (user ID, gender, age, etc.) of the user in a storage unit 120 in association with the QAC triple information. As described above, in the information processing system 1, when the meta information such as the gender and the age of the user who has performed the input (input user) is acquired, the QAC triple and the attribute of the input user can be associated with each other by associating the meta information with the information input by the input user. As a result, the information processing system 1 can construct the interaction system that performs an appropriate conversation according to the attribute of the user.

Here, there are various methods for creating conversation scenario data. Examples include a method for converting actual human conversation into data, a method for creating data by a specialized writer, a method for collecting data using a social networking service (SNS) or a web page, and automatic creation. These methods have problems of cost and quality in creating conversation data, and a method for efficiently creating the conversation data has been desired.

For example, in methods for creating data of actual human conversation and creating data by a specialized writer, high-quality data can be prepared, but there is a problem that the preparation cost is extremely high.

In addition, data collection using an SNS or a web page and automatic creation have a problem that the quality of obtained data cannot be guaranteed while the preparation cost is low. Specifically, there is a possibility that utterances with inappropriate grammar or utterances that do not make sense, including text input mistakes and net slangs, are collected and created. Still more, it is difficult to acquire a large amount of data associated with a specific answer subjects.

As an approach to solve the above problem, for example, there is a system that creates and collects input information associated with the answer subject and answer information with respect to the input information by a plurality of persons (pretending question and answer system).

Furthermore, in order to realize natural conversation in the interaction system, a “flow of response” and a “flow of conversation topic” are important. As for the “flow of response”, a more natural flow can be realized by collecting information on a chain conversation including not only certain information and an answer to that information but also a response to the answer like the QAC triple, and using the information for constructing the interaction system.

It is conceivable that information like the QAC triple is extracted from enormous data (big data) on the Internet communication, such as via a social networking service (SNS). However, there are problems that the quality of extracted data cannot be guaranteed and that it is difficult to acquire a large amount of data associated with specific answer subjects. To extract information suitable for the QAC triple from enormous data (big data) on the Internet, the cost required for enhancing the quality of data becomes enormous because target data is enormous. Therefore, to extract information suitable for the QAC triple from enormous data (big data) on the Internet, it is difficult to suppress an increase in cost.

Therefore, the information processor 100 presents the question (Q) to the user U1 and causes the user U1 to input the answer (A) and the comment (C), thereby collecting the combination (QAC triple) of the first information (question), the second information (answer), and the third information (response). As described above, the information processor 100 prompts the user to input the information for generating the QAC triple, thereby collecting the information for the QAC triples. In other words, the information processor 100 can easily collect data including the QAC of “question (Q) by the character”, “answer (A) by the user to the character's question Q”, and “comment (C) by the character on the user's answer A”. As a result, the information processor 100 can easily collect information for improving natural conversation by the interaction system while suppressing an increase in cost of collecting the QAC triple.

As described above, the information processor 100 collects a triple of Q-A-C (QAC triple) of the specific character and the meta information of the user, and stores the collected information in the storage unit 120. In this manner, the information processor 100 can easily collect the second information (A) and the third information (C) associated with the specific character and the user meta information. Although details will be described later, the information processing system 1 can easily construct the flow of conversation topic by a scenario puzzle in which the collected QAC triple (also referred to as “mini-scenario”) and a connective word are combined. In addition, the information processing system 1 can easily construct a scenario type interaction system by automatically branching the first information (Q) in one mini-scenario to the second information (A).

[1-1-1. Subject]

The example in FIG. 1 illustrates a case where a subject asking the question, which is the first information, and making the comment, which is the third information, is the character (interaction system), and a subject responding the answer, which is the second information, is the user. However, a subject of action corresponding to each of the first information, the second information, and the third information may be any subject. For example, the subject of the first information and the third information may be a first character, and the subject of the second information may be a second character different from the first character. Furthermore, for example, the subject of the first information may be the first character, the subject of the second information may be the user, and the subject of the third information may be the second character different from the first character. As described above, the information processing system 1 may collect the QAC triples of the first information, the second information, and the third information from various subjects.

[1-1-2. Input information]

The example in FIG. 1 illustrates the case where the information processor 100 collects the QAC triples by presenting the question to the user U1 and prompting the user U1 to input the answer to the question and the comment. Specifically, the example in FIG. 1 illustrates the case where the question prepared in advance on the information processor 100 side is presented to the user U1 to prompt one user U1 to input the second information (answer) and the third information (response) to collect the QAC triple. However, the information may be acquired in any manner as long as the information including the first information, the second information, and the third information can be acquired.

For example, in the information processing system 1, the first information may be acquired from a first user, the second information may be acquired from a second user, and the third information may be acquired from a third user. In this case, the first user, the second user, and the third user may be different from each other. In addition, out of the first user, the second user, and the third user, two users may be the same user, and only the remaining one user may be different. For example, the second user and the third user may be the same user, and only the first user may be another user. Furthermore, all of the first user, the second user, and the third user may be the same user.

For example, in the information processing system 1, the answer to the question and the comment on the answer may be input by different users. In this case, the information processing system 1 acquires the answer to the question from the user to whom the question has been presented. Then, the information processing system 1 presents the answer acquired from the user and the question corresponding to the answer to another user, thereby acquiring the comment on the answer from another user.

For example, the information processing system 1 may prompt the user to input the question. Then, in the information processing system 1, the question input by the user may be used as the first information. In this case, the information processing system 1 may present the question input by one user to another user and prompt the user U1 to input the answer and comment to the question.

### 1-2. Configuration of Information Processing System According to Embodiment

The information processing system 1 illustrated in FIG. 2 will be described. As illustrated in FIG. 2, the information processing system 1 includes the terminal device 10 and the information processor 100. The terminal device 10 and the information processor 100 are communicably connected in a wired or wireless manner via a predetermined communication network (network N). FIG. 2 is a diagram illustrating a configuration example of the information processing system according to the embodiment. Note that the information processing system 1 illustrated in FIG. 2 may include a plurality of terminal devices 10 and a plurality of information processors 100. For example, the information processing system 1 realizes the interaction system described above.

The terminal device 10 is the information processor used by the user. The terminal device 10 is used to provide a service related to interaction using voice or text. The terminal device 10 may be any device as long as the processing in the embodiment can be realized. The terminal device 10 may be any device as long as it provides a service related to interaction and has a display (display unit 16) that displays information. Furthermore, the terminal device 10 may be, for example, a device such as a smartphone, a tablet terminal, a notebook personal computer (PC), a desktop PC, a mobile phone, and a personal digital assistant (PDA). In the example in FIG. 1, the terminal device 10 is the tablet terminal used by the user U1.

Note that the terminal device 10 may include a sound sensor (microphone) that detects sound. In this case, the terminal device 10 detects the user's utterance by the sound sensor. The terminal device 10 collects not only the user's utterance but also environmental sound and the like around the terminal device 10. Furthermore, the terminal device 10 is not limited to the sound sensor, and includes various sensors. For example, the terminal device 10 may include a sensor that detects various types of information such as an image, acceleration, temperature, humidity, position, pressure, light, gyro, and distance. As described above, the terminal device 10 is not limited to the sound sensor, and may include various sensors such as an image sensor (camera) that detects an image, an acceleration sensor, a temperature sensor, a humidity sensor, a position sensor such as a GPS sensor, a pressure sensor, light sensor, a gyro sensor, and a distance measuring sensor. Furthermore, the terminal device 10 is not limited to the above-described sensors, and may include various sensors such as an illuminance sensor, a proximity sensor, and a sensor for detecting biological information such as smell, sweat, heartbeat, pulse, and brain waves. Then, the terminal device 10 may transmit various pieces of sensor information detected by various sensors to the information processor 100. The terminal device 10 may include software modules such as audio signal processing, voice recognition, utterance semantic analysis, interaction control, and action output.

The information processor 100 is used to provide a service related to the interaction system to the user. The information processor 100 performs various types of information processing related to the interaction system with the user. The information processor 100 is a computer that collects a combination of the first information serving as the trigger for interaction, the second information indicating the answer to the first information, and the third information indicating the response the second information. The information processor 100 is a computer that generates the scenario information indicating a flow of interaction based on a plurality of pieces of unit information that is information of an interaction constituent unit corresponding to the combination of first information serving as the trigger for interaction, the second information indicating the answer to the first information, and the third information indicating the response to the second information. Note that the constituent unit of the interaction here may be the combination (QAC triple) of the first information, the second information, and the third information, or may be each of the first information, the second information, and the third information.

Furthermore, the information processor 100 may include software modules such as audio signal processing, voice recognition, utterance semantic analysis, and interaction control. The information processor 100 may have a function of voice recognition. Furthermore, the information processor 100 may be able to acquire information from voice recognition server that provides a voice recognition service. In this case, the information processing system 1 may include the voice recognition server. For example, the information processor 100 or the voice recognition server recognizes utterance by the user or identifies the user who has uttered by appropriately using various conventional technologies.

Note that the information processor 100 may collect information such as the combinations (QAC triples) and generate information such as scenario information, and another device may provide the service related to the interaction system to the user. In this case, the information processing system 1 may include an interaction service providing device that provides a service related to the interaction system to the user. In this case, the information processor 100 may provide the collected information or the generated information to the interaction service providing device.

### 1-3. Configuration of Information Processor According to Embodiment

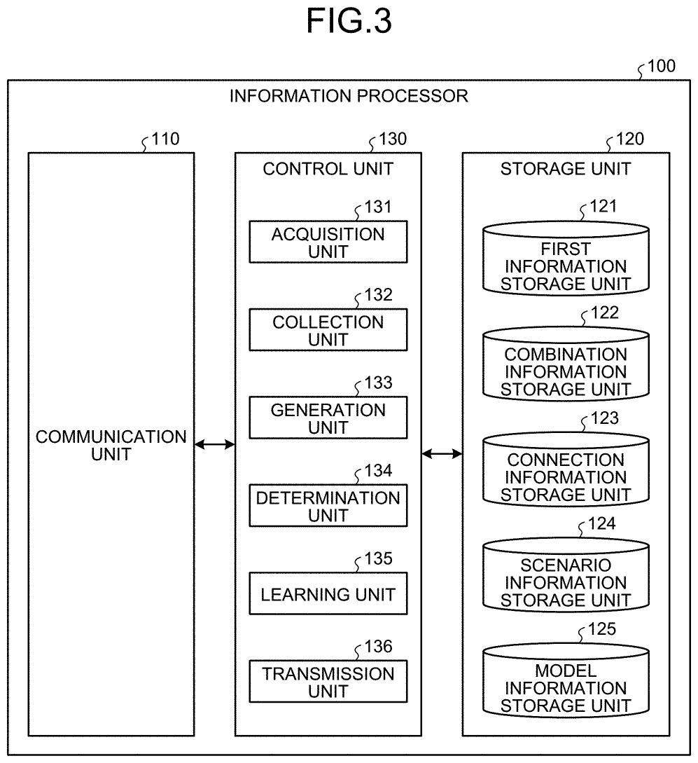

Next, a configuration of the information processor 100 that is an example of the information processor that executes information processing according to the embodiment will be described. FIG. 3 is a diagram illustrating a configuration example of the information processor 100 according to the embodiment of the present disclosure.

As illustrated in FIG. 3, the information processor 100 includes a communication unit 110, the storage unit 120, and a control unit 130. Note that the information processor 100 may include an input unit (for example, a keyboard or a mouse) that receives various operations from an administrator or the like of the information processor 100, and a display unit (for example, a liquid crystal display) for displaying various types of information.

The communication unit 110 is realized by, for example, a network interface card (NIC). Then, the communication unit 110 is connected to the network N (see FIG. 2) in a wired or wireless manner, and transmits and receives information to and from another information processor such as the terminal device 10 or the voice recognition server. Furthermore, the communication unit 110 may transmit and receive information to and from a user terminal (not illustrated) used by the user.

The storage unit 120 is realized by, for example, a semiconductor memory element such as a random access memory (RAM) or a flash memory, or a storage device such as a hard disk or an optical disk. As illustrated in FIG. 3, the storage unit 120 according to the embodiment includes a first information storage unit 121, a combination information storage unit 122, a connection information storage unit 123, a scenario information storage unit 124, and a model information storage unit 125.

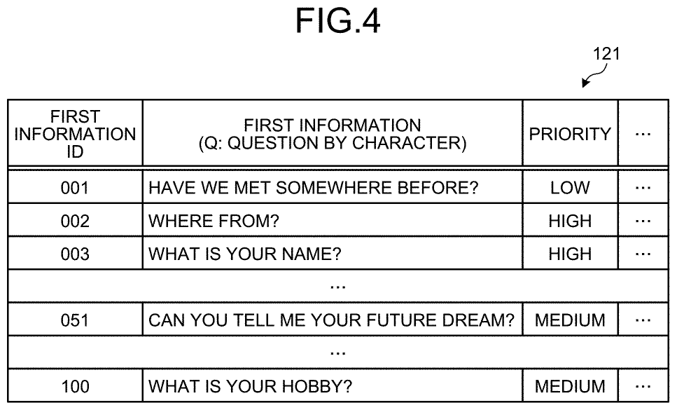

The first information storage unit 121 according to the embodiment stores various types of information regarding the first information. The first information storage unit 121 stores various types of information regarding the first information serving as the trigger for interaction such as a question to the user. FIG. 4 is a diagram illustrating an example of the first information storage unit according to the embodiment. The first information storage unit 121 illustrated in FIG. 4 includes items such as “first information ID”, “first information (Q: Question by character)”, and “priority”.

The “first information ID” indicates identification information for identifying the first information. The “first information (Q: Question by character)” indicates the first information. In the example in FIG. 4, the “first information (Q: Question by character)” indicates a character question “Q” as an example of the first information. The “priority” indicates the priority of each piece of the first information. The “priority” indicates the priority of each piece of the first information at presenting the first information to the user. Although the example in FIG. 7 illustrates a case where the “priority” is classified into three levels of “low”, “medium”, and “high”, the “priority” is not limited to three levels, and may be various classifications (degrees) such as 10 levels from “1” to “10”.

In the example in FIG. 4, the first information identified by the first information ID “001” is “Have we met somewhere before?”. In addition, the example indicates that the question “Have we met somewhere before?”, which is the first information identified by the first information ID “001”, has “low” priority.

In addition, the first information identified by the first information ID “002” indicates that “Where from?”. In addition, the question “Where from?”, which is the first information identified by the first information ID “002”, indicates that the priority is “high”.

Note that the first information storage unit 121 is not limited to the above, and may store various types of information depending on the purpose. For example, the first information storage unit 121 may store, in association with the first information ID, the number of times each piece of the first information is presented to the user or the number of combinations including each piece of the first information.

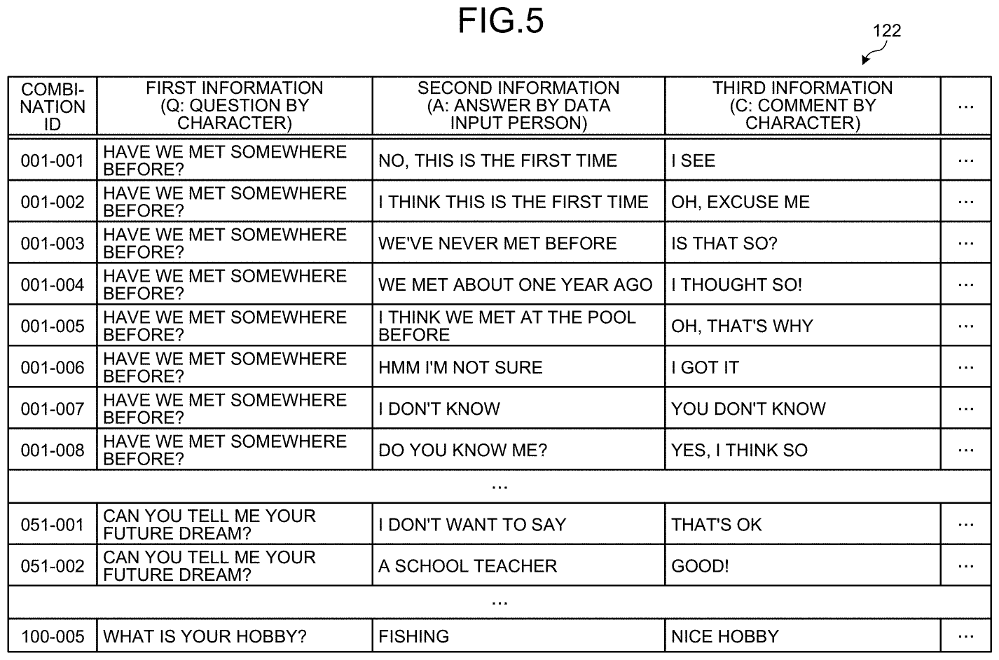

The combination information storage unit 122 according to the embodiment stores various types of information regarding the collected combination. The combination information storage unit 122 stores various types of information related to the combinations of the first information, the second information, and the third information. FIG. 5 is a diagram illustrating an example of the combination information storage unit according to the embodiment. The combination information storage unit 122 illustrated in FIG. 5 includes items such as “combination ID”, “first information (Q: Question by character)”, “second information (A: Answer by the data input person)”, and “third information (C: Comment by the character)”.

The “combination ID” indicates identification information for identifying the combination of the first information, the second information, and the third information. The “combination ID” indicates the identification information for identifying the combination (QAC triple).

The “first information (Q: Question by character)” indicates the first information in the combination (QAC triple) identified by the corresponding combination ID. In the example in FIG. 5, the “first information (Q: Question by character)” indicates the character's question “Q” as an example of the first information.

“Second information (A: Answer by data input person)” indicates the second information of the combination (QAC triple) identified by the corresponding combination ID. In the example in FIG. 5, the “second information (A: Answer by data input person)” indicates the data input person's answer “A” to the character's question “Q” by the character as an example of the second information.

The “third information (C: Comment by character)” indicates the third information in the combination (QAC triple) identified by the corresponding combination ID. In the example in FIG. 5, the third information (C: Comment by character) indicates the character's comment “C” to the data input person's answer “A” as an example of the third information.

In the example in FIG. 5, the combination (QAC triple) identified by a combination ID “001-001” indicates that the first information is “Have we met somewhere before?”, the second information is “No, this is the first time”, and the third information is “I see”. In addition, the combination (QAC triple) identified by a combination ID “001-002” indicates that the first information is “Have we met somewhere before?”, the second information is “I think this is the first time”, and the third information is “Oh, excuse me”.

Note that the above is an example, and the combination information storage unit 122 is not limited to the above, and may store various types of information depending on the purpose. The combination information storage unit 122 may store, in each row, an identification ID (user ID) of the data input person and information of a user attribute (age, sex, hometown, and the like). For example, the combination information storage unit 122 may store the meta information of the user who has input each combination (QAC triple) in association with each combination. The combination information storage unit 122 may store information regarding a demographic attribute and information regarding a psychographic attribute of the user who has input the combination in association with the combination ID for identifying each combination (QAC triple). For example, the combination information storage unit 122 may store information, in association with the combination ID, such as the age, sex, hobby, family structure, income, lifestyle, and the like of the user who has input the combination.

For example, when the second information or the third information in the combination (QAC triple) identified by the combination ID “001-001” has been input by a male user in his twenties, the combination information storage unit 122 may store information such as “twenties” and “male” as the meta information of the user in association with the combination ID “001-001”. In addition, the combination information storage unit 122 may store the user ID of the user who has input the combination in association with the combination ID.

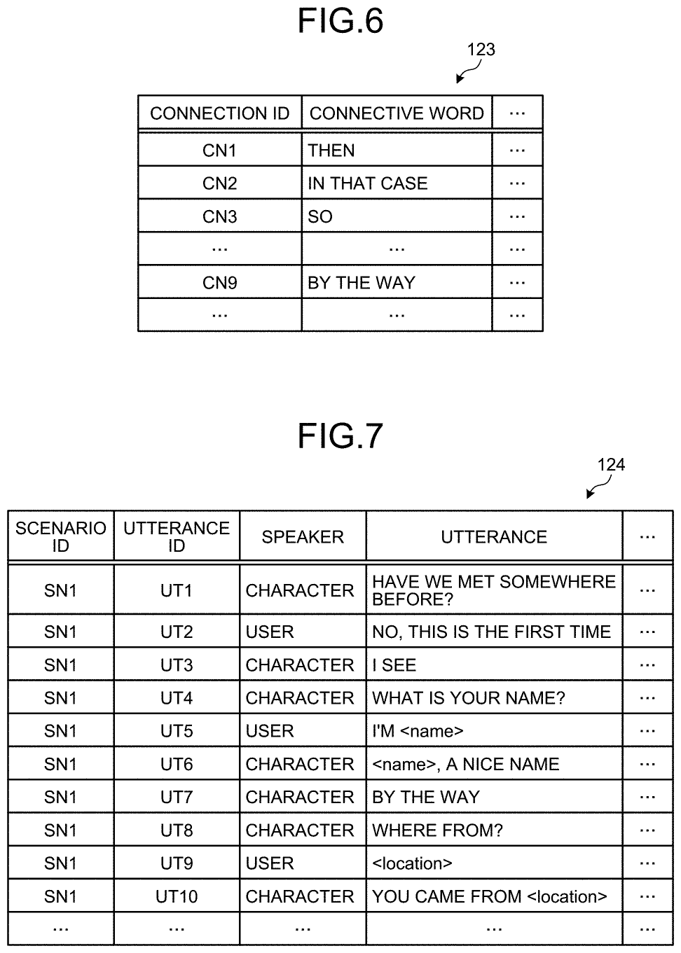

The connection information storage unit 123 according to the embodiment stores connection information that is information on connection of the combinations. For example, the connection information storage unit 123 stores connection information such as conjunctions. FIG. 6 is a diagram illustrating an example of the connection information storage unit according to the embodiment. The connection information storage unit 123 illustrated in FIG. 6 includes items such as “connection ID” and “connective word”.

The “connection ID” indicates identification information for identifying a connective word such as a conjunction. For example, the “connective word” indicates a character string connecting the combinations, such as a conjunction.

In the example in FIG. 6, the connective word identified by the connection ID “CN1” (connective word CN1) indicates conjunction “Then”. In addition, a connective word identified by the connection ID “CN2” (connective word CN2) indicates conjunction “In that case”.

Note that the connection information storage unit 123 is not limited to the above, and may store various types of information depending on the purpose. The connection information storage unit 123 may store information indicating the application (function) of each connective word in association with each connective word. For example, the connection information storage unit 123 may store information indicating whether each connective word, such as a conjunction, is equivalent/causal, contrary, parallel/addition, supplement/reason explanation, comparison/selection, conversion, or the like in association with each connective word.

The scenario information storage unit 124 according to the embodiment stores various types of information regarding the scenario. The scenario information storage unit 124 stores various types of information regarding the scenario in which a plurality of combinations is connected. FIG. 7 is a diagram illustrating an example of the scenario information storage unit according to the embodiment. The scenario information storage unit 124 illustrated in FIG. 7 includes items such as “scenario ID”, “utterance ID”, “speaker”, and “utterance”.

The “scenario ID” indicates identification information for identifying the scenario. The “utterance ID” indicates identification information for identifying utterance. Furthermore, a “speaker” indicates the speaker who is the subject utterance identified by the corresponding utterance ID. The “utterance” indicates a specific utterance identified by the corresponding utterance ID.

The example in FIG. 7 shows that a scenario identified by a scenario ID “SN1” (scenario SN1) includes utterances identified by utterance IDs “UT1” to “UT10” (utterances UT1 to UT10). The scenario SN1 indicates a scenario that has been uttered in the order of the utterances UT1 to UT10.

The utterance identified by the utterance ID “UT1” (utterance UT1) indicates that the speaker is the character and its content is “Have we met somewhere before?”. In other words, the utterance UT1 indicates that the subject (speaker) of the utterance UT1 is the character of the interactive agent. As described above, the utterance UT1 indicates that the utterance is the question “Have we met somewhere before?” by the character of the interactive agent to prompt the user to utter. For example, the utterance UT1 corresponds to the utterance serving as the trigger for interaction (first information).

The utterance identified by the utterance ID “UT2” (utterance UT2) indicates that the speaker is the user and its content is “No, this is the first time”. In other words, the utterance UT2 indicates that the subject (speaker) of the utterance UT2 is the user who uses the interactive agent. As described above, the utterance UT2 indicates that the utterance is the answer “No, this is the first time” by the user who uses the interactive agent to the utterance UT1 by the character of the interactive agent. For example, the utterance UT2 corresponds to the utterance indicating the answer (second information) to the first information.

The utterance identified by the utterance ID “UT3” (utterance UT3) indicates that the speaker is the character and its content is “I see”. In other words, the utterance UT3 indicates that the subject (speaker) of the utterance UT3 is the character of the interactive agent.

As described above, the utterance UT3 indicates that the utterance is the response “I see” by the character of the interactive agent to the answer by the user. For example, the utterance UT3 corresponds to the utterance indicating the response (third information) to the second information.

Note that the scenario information storage unit 124 is not limited to the above, and may store various types of information depending on the purpose. For example, the scenario information storage unit 124 is not limited to the scenario SN1, and may store information regarding a large number of scenarios.

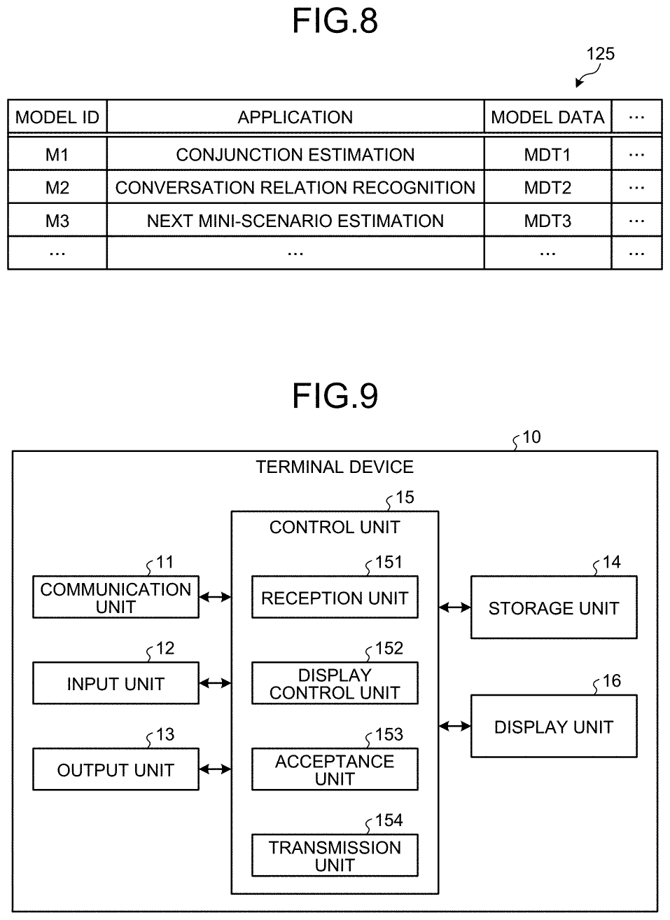

The model information storage unit 125 according to the embodiment stores information regarding a model. For example, the model information storage unit 125 stores model information (model data) learned (generated) by a learning process. FIG. 8 is a diagram illustrating an example of the model information storage unit according to a first embodiment of the present disclosure. FIG. 8 illustrates the example of the model information storage unit 125 according to the first embodiment. In the example illustrated in FIG. 8, the model information storage unit 125 includes items such as “model ID”, “application”, and “model data”.

The “model ID” indicates identification information for identifying the model. The “application” indicates the purpose of use of the corresponding model. The “model data” indicates data of the model. Although FIG. 8 illustrates an example in which conceptual information such as “MDT1” is stored in the “model data”, various types of information constituting the model, such as information and function regarding a network included in the model, are actually included in the model data.

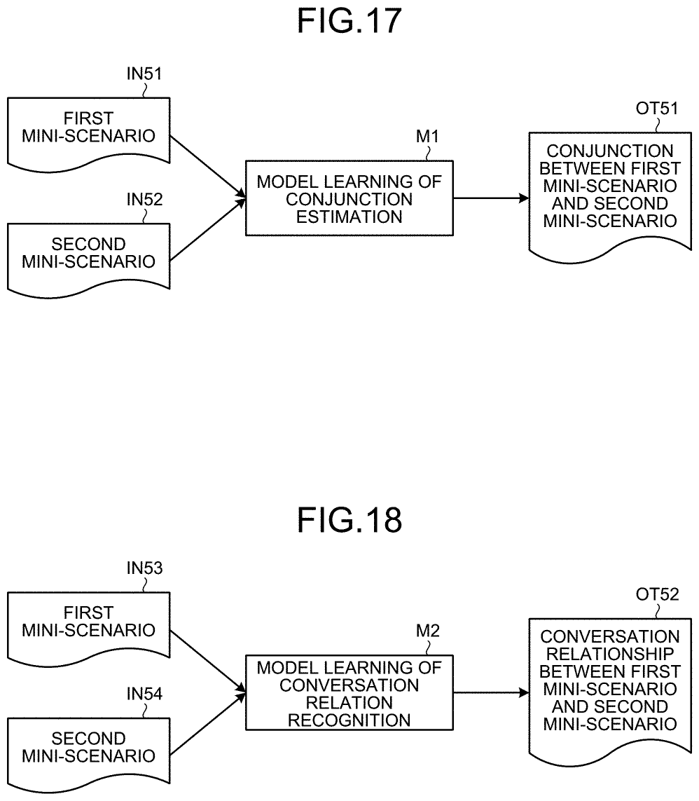

In the example illustrated in FIG. 8, the model identified by a model ID “M1” (model M1) indicates that the application is “conjunction estimation”. The model ID “M1” also indicates that the model data of the model M1 is model data MDT1. For example, as illustrated in FIG. 17, when two mini-scenarios (combinations) are input, the model M1 is a model that outputs information for estimating a conjunction to enter between the two mini-scenarios.

In addition, a model identified by a model ID “M2” (model M2) indicates that the application is “conversation relation recognition”. The model ID “M2” also indicates that the model data of the model M2 is model data MDT2. For example, as illustrated in FIG. 18, when two mini-scenarios (combinations) are input, the model M2 is a model that outputs information used for recognition (determination) of the conversation relationship between the two mini-scenarios.

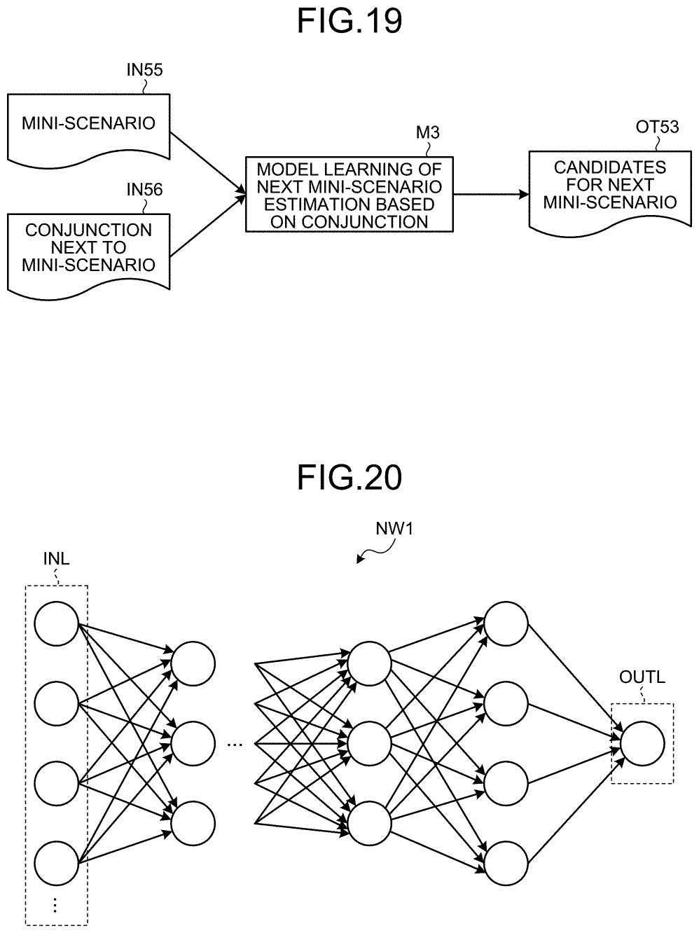

In addition, a model identified by a model ID “M3” (model M3) indicates that the application is “next mini-scenario estimation”. The model ID “M3” also indicates that the model data of the model M3 is model data MDT3. For example, as illustrated in FIG. 19, when one mini-scenario (combination) and a conjunction next to the one mini-scenario are input, the model M3 is a model that outputs information indicating a candidate of a mini-scenario (combination) after the one mini-scenario (combination).

Note that the model information storage unit 125 is not limited to the above, and may store various types of information depending on the purpose.

Returning to FIG. 3, the description will be continued. The control unit 130 is realized by, for example, a central processing unit (CPU), a micro processing unit (MPU), or the like executing a program (for example, an information processing program or the like according to the present disclosure) stored inside the information processor 100 with a random access memory (RAM) or the like as a work area. Furthermore, the control unit 130 is a controller, and is realized by, for example, an integrated circuit such as an application specific integrated circuit (ASIC) or a field programmable gate array (FPGA).

As illustrated in FIG. 3, the control unit 130 includes an acquisition unit 131, a collection unit 132, a generation unit 133, a determination unit 134, a learning unit 135, and a transmission unit 136, and realizes or executes a function and an action of information processing described below. Note that the internal configuration of the control unit 130 is not limited to the configuration illustrated in FIG. 3, and may be another configuration as long as information processing to be described later is performed. Furthermore, the connection relationship among the processing units included in the control unit 130 is not limited to the connection relationship illustrated in FIG. 3, and may be another connection relationship.

The acquisition unit 131 acquires various types of information. The acquisition unit 131 acquires various types of information from an external information processor. The acquisition unit 131 acquires various types of information from the terminal device 10. The acquisition unit 131 acquires various types of information from another information processor such as a voice recognition server.

The acquisition unit 131 acquires various types of information from the storage unit 120. The acquisition unit 131 acquires various types of information from the first information storage unit 121, the combination information storage unit 122, the connection information storage unit 123, the scenario information storage unit 124, and the model information storage unit 125.

For example, the acquisition unit 131 may acquire the model. The acquisition unit 131 acquires the model from the external information processor that provides the model or the storage unit 120. For example, the acquisition unit 131 acquires models M1 to M3 and the like from the model information storage unit 125.

The acquisition unit 131 acquires various types of information analyzed by the collection unit 132. The acquisition unit 131 acquires various types of information generated by the generation unit 133. The acquisition unit 131 acquires various types of information generated by the generation unit 133. The acquisition unit 131 acquires various types of information determined by the determination unit 134. The acquisition unit 131 acquires various types of information learned by the learning unit 135.

The acquisition unit 131 acquires the first information serving as the trigger for interaction, the second information indicating the answer to the first information, and the third information indicating the response to the second information. The acquisition unit 131 acquires the first information that is the question, the second information that is the reply to the first information, and the third information that is the reply to the second information. The acquisition unit 131 acquires the first information corresponding to utterance by the first subject, the second information corresponding to utterance by the second subject, and the third information corresponding to utterance by the third subject. The acquisition unit 131 acquires the first information, the second information corresponding to the utterance by the second subject different from the first subject, and the third information corresponding to the utterance by the third subject that is the first subject.

The acquisition unit 131 acquires the first information corresponding to the utterance by the first subject that is the agent of the interaction system, the second information corresponding to the utterance by the second subject that is the user, and the third information corresponding to the utterance by the third subject that is the agent of the interaction system. The acquisition unit 131 acquires the first information, the second information, and the third information in which at least one of the first information, the second information, and the third information is input by the user. The acquisition unit 131 acquires the first information presented to the input user, the second information input by the input user, and the third information input by the input user. The acquisition unit 131 acquires the meta information of the input user.

The acquisition unit 131 acquires a plurality of pieces of unit information that is information of the interaction constituent unit corresponding to the combination of the first information serving as the trigger for interaction, the second information indicating the answer to the first information, and the third information indicating the response to the second information. The acquisition unit 131 acquires the plurality of pieces of unit information of the constituent unit that is the combination of the first information, the second information, and the third information. The acquisition unit 131 acquires designation information on a way of connecting the combinations by the user to whom the plurality of pieces of unit information is presented. The acquisition unit 131 acquires the connection information that is information on connection of the first information, the second information, and the third information in the combination. The acquisition unit 131 acquires the connection information designated by the user. The acquisition unit 131 acquires the plurality of pieces of the unit information of the constituent unit that is each of the first information, the second information, and the third information.

In the example in FIG. 1, the acquisition unit 131 acquires the second information that is the answer input by the user U1 and the third information that is the comment input by the user U1. The acquisition unit 131 acquires the information indicating the answer “No, this is the first time” and the information indicating the comment “I see” input by the user U1.

The collection unit 132 collects various types of information. The collection unit 132 collects various types of information on the basis of information from an external information processor. The collection unit 132 collects various types of information on the basis of the information from the terminal device 10. The collection unit 132 collects information transmitted from the terminal device 10. The collection unit 132 stores various types of information in the storage unit 120. The collection unit 132 stores the information transmitted from the terminal device 10 in the storage unit 120. The collection unit 132 collects various types of information by storing various types of information in the storage unit 120. The collection unit 132 collects various types of information by storing various types of information in the first information storage unit 121, the combination information storage unit 122, the connection information storage unit 123, the scenario information storage unit 124, and the model information storage unit 125.

The collection unit 132 analyzes various types of information. The collection unit 132 analyzes various types of information on the basis of information from the external information processor and information stored in the storage unit 120. The collection unit 132 analyzes various types of information from the storage unit 120. The collection unit 132 analyzes various types of information on the basis of information stored in the first information storage unit 121, the combination information storage unit 122, the connection information storage unit 123, the scenario information storage unit 124, and the model information storage unit 125. The collection unit 132 specifies various types of information. The collection unit 132 estimates various types of information.

The collection unit 132 extracts various types of information. The collection unit 132 selects various types of information. The collection unit 132 extracts various types of information on the basis of information from the external information processor and information stored in the storage unit 120. The collection unit 132 extracts various types of information from the storage unit 120. The collection unit 132 extracts various types of information from the first information storage unit 121, the combination information storage unit 122, the connection information storage unit 123, the scenario information storage unit 124, and the model information storage unit 125.

The collection unit 132 extracts various types of information on the basis of the various types of information acquired by the acquisition unit 131. The collection unit 132 extracts various types of information on the basis of the information generated by the generation unit 133. Furthermore, the collection unit 132 extracts various types of information on the basis of the various types of information determined by the determination unit 134. The collection unit 132 extracts various types of information on the basis of the various types of information learned by the learning unit 135.

The collection unit 132 collects the combination of the first information, the second information, and the third information acquired by the acquisition unit 131. The collection unit 132 stores the combination of the first information, the second information, and the third information in the storage unit 120. The collection unit 132 associates the input user's meta information acquired by the acquisition unit 131 with the combination of the first information, the second information, and the third information.

In the example in FIG. 1, the collection unit 132 collects the QAC triples by storing the combination (QAC triple) of the question (Q) presented to the user U1, and the answer (A) and the comment (C) input by the user U1 in the combination information storage unit 122. The collection unit 132 stores the combination of the information indicating the question “Have we met somewhere before?”, the information indicating the answer “No, this is the first time”, and the information indicating the comment “I see” as the QAC triple in the combination information storage unit 122.

The generation unit 133 generates various types of information. The generation unit 133 generates various types of information on the basis of information from an external information processor or information stored in the storage unit 120. The generation unit 133 generates various types of information on the basis of information from another information processor such as the terminal device 10 or the voice recognition server. The generation unit 133 generates various types of information on the basis of information stored in the first information storage unit 121, the combination information storage unit 122, the connection information storage unit 123, the scenario information storage unit 124, and the model information storage unit 125.

The generation unit 133 generates various types of information on the basis of the various types of information acquired by the acquisition unit 131. The generation unit 133 generates various types of information on the basis of the various types of information collected by the collection unit 132. The generation unit 133 generates various types of information on the basis of the various types of information analyzed by the collection unit 132. The generation unit 133 generates various types of information on the basis of the various types of information determined by the determination unit 134. The generation unit 133 generates various types of information on the basis of the various types of information learned by the learning unit 135.

The generation unit 133 generates various types of information such as a screen (image information) to be provided to the external information processor by appropriately using various technologies. The generation unit 133 generates a screen (image information) or the like to be provided to the terminal device 10. For example, the generation unit 133 generates the screen (image information) or the like to be provided to the terminal device 10 on the basis of the information stored in the storage unit 120. In the example in FIG. 1, the generation unit 133 generates the content CT11. The generation unit 133 may generate the screen (image information) or the like by any processing as long as the screen (image information) or the like to be provided to the external information processor can be generated. For example, the generation unit 133 generates the screen (image information) to be provided to the terminal device 10 by appropriately using various technologies related to image generation, image processing, and the like. For example, the generation unit 133 generates the screen (image information) to be provided to the terminal device 10 by appropriately using various technologies such as Java (registered trademark). Note that the generation unit 133 may generate the screen (image information) to be provided to the terminal device 10 on the basis of a format such as CSS, JavaScript (registered trademark), or HTML. Furthermore, for example, the generation unit 133 may generate the screen (image information) in various formats such as joint photographic experts group (JPEG), graphics interchange format (GIF), and portable network graphics (PNG).

The generation unit 133 generates the scenario information indicating the flow of interaction on the basis of the plurality of pieces of unit information acquired by the acquisition unit 131. The generation unit 133 generates the scenario information including a plurality of combinations by connecting the plurality of combinations. The generation unit 133 generates the scenario information on the basis of the designation information designated by the user. The generation unit 133 generates the scenario information in which the connection information is arranged between the combinations to be connected. The generation unit 133 generates the scenario information on the basis of the connection information designated by the user.

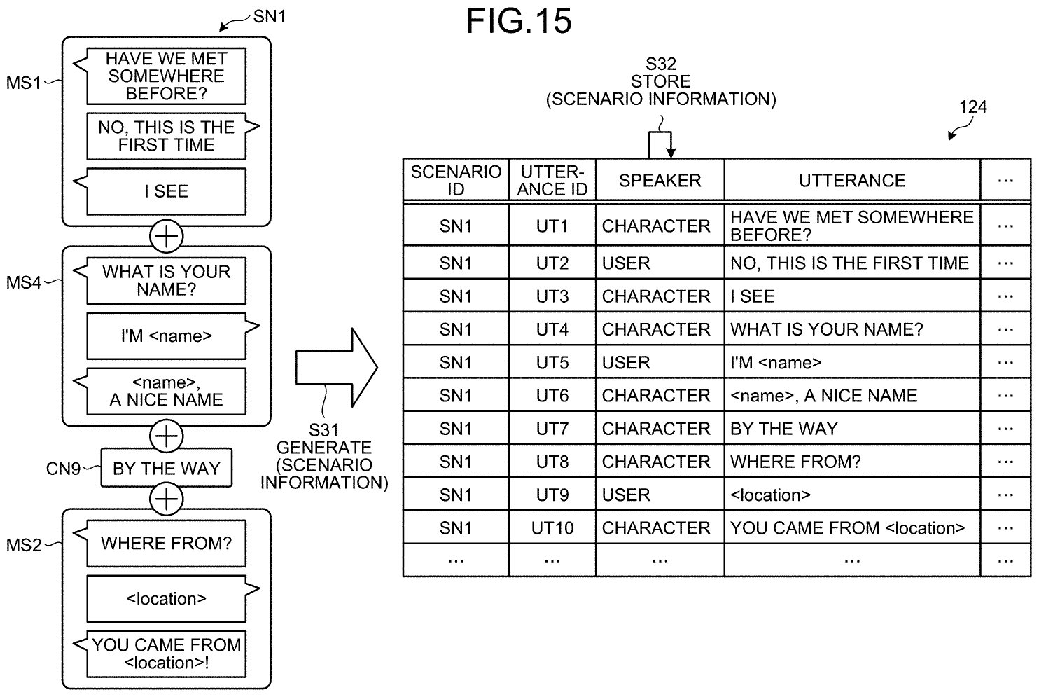

In the example in FIG. 15, the generation unit 133 generates the scenario information on the basis of information arranged in the order of a mini-scenario MS1, a mini-scenario MS4, a connective word CN9, and a mini-scenario MS2. The generation unit 133 generates the scenario information in which the mini-scenario MS1, the mini-scenario MS4, the connective word CN9, and the mini-scenario MS2 are arranged in this order. The generation unit 133 stores the generated scenario information in the scenario information storage unit 124. The generation unit 133 stores each utterance included in the mini-scenario MS1, each utterance included in the mini-scenario MS4, the connective word CN9, and each utterance included in the mini-scenario MS2 in the scenario information storage unit 124 in association with one scenario ID “SN1”.

The determination unit 134 determines various types of information. The determination unit 134 makes various determinations. For example, the determination unit 134 determines various types of information on the basis of information from an external information processor or information stored in the storage unit 120. The determination unit 134 determines various types of information on the basis of information from another information processor such as the terminal device 10 or the voice recognition server. The determination unit 134 determines various types of information on the basis of information stored in the first information storage unit 121, the combination information storage unit 122, the connection information storage unit 123, the scenario information storage unit 124, and the model information storage unit 125.

The determination unit 134 determines various types of information on the basis of the various types of information acquired by the acquisition unit 131. The determination unit 134 determines various types of information on the basis of the various types of information collected by the collection unit 132. The determination unit 134 determines various types of information on the basis of the various types of information analyzed by the collection unit 132. The determination unit 134 determines various types of information on the basis of the various types of information generated by the generation unit 133. The determination unit 134 determines various types of information on the basis of the various types of information learned by the learning unit 135. The determination unit 134 makes various decisions on the basis of the determinations. Various decisions are made based on the information acquired by the acquisition unit 131.

For example, the determination unit 134 determines the question to be presented to the user by appropriately using various types of information such as a priority of each question and the number of times of presentation. In the example in FIG. 1, the determination unit 134 determines to present the question “Have we met somewhere before?” having the smallest first information ID. The determination unit 134 may determine the question to present at random.

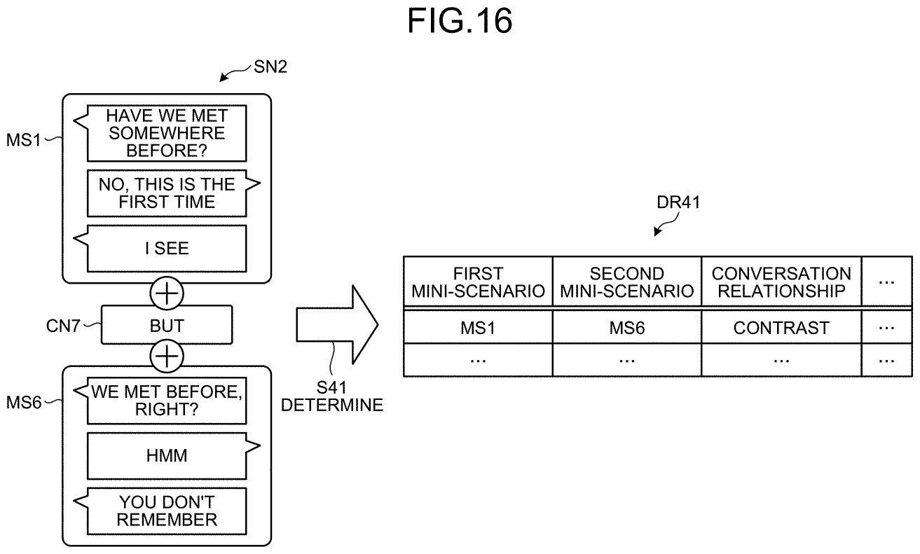

The determination unit 134 performs conversation relation recognition. The determination unit 134 performs conversation relation recognition between mini-scenarios (QAC triples) as illustrated in FIG. 16.

The learning unit 135 performs the learning process. The learning unit 135 performs various kinds of learning. The learning unit 135 learns (generates) a model. The learning unit 135 learns various types of information such as the model. The learning unit 135 generates the model by learning. The learning unit 135 learns the model using various technologies related to machine learning. The learning unit 135 updates the model by learning. For example, the learning unit 135 learns a network parameter.

For example, the learning unit 135 learns various types of information on the basis of information from an external information processor or information stored in the storage unit 120. The learning unit 135 learns various types of information on the basis of information from another information processor such as the terminal device 10. The learning unit 135 learns various types of information on the basis of information stored in the first information storage unit 121, the combination information storage unit 122, the connection information storage unit 123, or the scenario information storage unit 124. The learning unit 135 stores the model generated by learning in the model information storage unit 125. The learning unit 135 generates the models M1 to M3 and the like.

The learning unit 135 learns various types of information on the basis of the various types of information acquired by the acquisition unit 131. The learning unit 135 learns various types of information on the basis of the various types of information collected by the collection unit 132. The learning unit 135 learns various types of information on the basis of the various types of information analyzed by the collection unit 132. The learning unit 135 learns various types of information on the basis of the various types of information generated by the generation unit 133. The learning unit 135 learns various types of information on the basis of the various types of information determined by the determination unit 134.

The learning unit 135 learns the model related to automatic generation of the scenario information on the basis of the information related to the scenario information generated by the generation unit 133. For example, the learning unit 135 generates the models M1 to M3 and the like. For example, the learning unit 135 generates the model used for various applications. For example, the learning unit 135 generates the model corresponding to a network NW1 as illustrated in FIG. 20.

The transmission unit 136 provides various types of information to an external information processor. The transmission unit 136 transmits various types of information to the external information processor. For example, the transmission unit 136 transmits various types of information to another information processor such as the terminal device 10 or the voice recognition server. The transmission unit 136 provides the information stored in the storage unit 120. The transmission unit 136 transmits the information stored in the storage unit 120.

The transmission unit 136 provides various types of information on the basis of information from another information processor such as the terminal device 10 or the voice recognition server. The transmission unit 136 provides various types of information on the basis of the information stored in the storage unit 120. The transmission unit 136 provides various types of information on the basis of information stored in the first information storage unit 121, the combination information storage unit 122, the connection information storage unit 123, the scenario information storage unit 124, or the model information storage unit 125.

In the example in FIG. 1, the transmission unit 136 transmits the content CT11, which is a QAC triple collection screen including the question, to the terminal device 10 used by the user U1. The transmission unit 136 transmits the content CT11 including the question “Have we met somewhere before?” to the terminal device 10 used by the user U1.

### 1-4. Configuration of Terminal Device According to Embodiment

Next, a configuration of the terminal device 10 that is an example of the information processor executing information processing according to the embodiment will be described. FIG. 9 is a diagram illustrating a configuration example of the terminal device according to the embodiment of the present disclosure.

As illustrated in FIG. 9, the terminal device 10 includes a communication unit 11, an input unit 12, an output unit 13, a storage unit 14, a control unit 15, and a display unit 16.

The communication unit 11 is realized by, for example, an NIC, a communication circuit, or the like. The communication unit 11 is connected to the network N (the Internet or the like) in a wired or wireless manner, and transmits and receives information to and from other devices such as the information processor 100 via the network N.

Various operations are input from the user to the input unit 12. Various types of information are input to the input unit 12 via the display unit 16. The input unit 12 may have a function of detecting voice. For example, the input unit 12 includes a keyboard or a mouse connected to the terminal device 10. Furthermore, the input unit 12 may include a button provided on the terminal device 10 or a microphone that detects voice.

For example, the input unit 12 may have a touch panel capable of realizing a function equivalent to that of a keyboard or a mouse. In this case, the input unit 12 receives various operations from the user via the display screen by a function of the touch panel realized by various sensors. In other words, the input unit 12 receives various operations from the user via the display unit 16 of the terminal device 10. For example, the input unit 12 receives an operation such as an operation designated by the user via the display unit 16 of the terminal device 10. For example, the input unit 12 functions as an acceptance unit that accepts the user's operation by the function of the touch panel. In this case, the input unit 12 and an acceptance unit 153 may be integrated. Note that, as a method of detecting the user's operation by the input unit 12, a capacitance method is mainly adopted in a tablet terminal, but any method may be adopted as long as the user's operation can be detected and the function of the touch panel can be realized, such as other detection methods including a resistive film method, a surface acoustic wave method, an infrared method, and an electromagnetic induction method.

The output unit 13 outputs various types of information. The output unit 13 has a function of outputting voice. For example, the output unit 13 includes a loudspeaker that outputs voice. The output unit 13 outputs information by voice to the user. The output unit 13 outputs the question by voice. The output unit 13 outputs the information displayed on the display unit 16 by voice. For example, the output unit 13 outputs information included in the content CT11 by voice.

The storage unit 14 is realized by, for example, a semiconductor memory element such as a RAM or a flash memory, or a storage device such as a hard disk or an optical disk. The storage unit 14 stores various types of information used for displaying information.

Returning to FIG. 9, the description will be continued. The control unit 15 is implemented by, for example, a CPU, an MPU, or the like executing a program (for example, a display program such as an information processing program according to the present disclosure) stored inside the terminal device 10 using a RAM or the like as a work area. Furthermore, the control unit 15 is a controller, and may be realized by, for example, an integrated circuit such as ASIC or FPGA.

As illustrated in FIG. 9, the control unit 15 includes a reception unit 151, a display control unit 152, an acceptance unit 153, and a transmission unit 154, and realizes or executes a function and an action of information processing described below. Note that the internal configuration of the control unit 15 is not limited to the configuration illustrated in FIG. 9, and may be another configuration as long as information processing to be described later is performed.

The reception unit 151 receives various types of information. The reception unit 151 receives various types of information from an external information processor. The reception unit 151 receives various types of information from other information processors such as the information processor 100 or the voice recognition server. In the example in FIG. 1, the reception unit 151 receives the content CT11.

The display control unit 152 controls various displays. The display control unit 152 controls display on the display unit 16. The display control unit 152 controls display on the display unit 16 according to reception by the reception unit 151. The display control unit 152 controls display on the display unit 16 on the basis of the information received by the reception unit 151. The display control unit 152 controls display on the display unit 16 on the basis of the information accepted by the acceptance unit 153. The display control unit 152 controls display on the display unit 16 according to acceptance by the acceptance unit 153. The display control unit 152 controls display of the display unit 16 such that the content CT11 is displayed on the display unit 16. In the example in FIG. 1, the display control unit 152 controls the display of the display unit 16 such that the content CT11 is displayed on the display unit 16.

The acceptance unit 153 accepts various types of information. For example, the acceptance unit 153 accepts an input by the user via the input unit 12. The acceptance unit 153 accepts an operation by the user. The acceptance unit 153 accepts the user's operation with respect to information displayed on the display unit 16. The acceptance unit 153 accepts utterance by the user as an input. The acceptance unit 153 accepts text input by the user.

In the example in FIG. 1, the acceptance unit 153 accepts the input by the user U1. The acceptance unit 153 accepts the input by the user U1 regarding the answer by the user U1 to the question in the content CT11 and the comment by the character to the answer.

The acceptance unit 153 accepts, in the second box BX12 of the content CT11, the input indicating the answer by the user U1 to the question “Have we met somewhere before?”. The acceptance unit 153 accepts the character string “No, this is the first time” as the answer to the question.

The acceptance unit 153 accepts, in the third box BX13 of the content CT11, the input indicating the comment by the character on the answer by the user U1 “No, this is the first time”. The acceptance unit 153 accepts the character string “I see” as the comment by the character on the answer by the user U1.

The transmission unit 154 transmits various types of information to an external information processor. For example, the transmission unit 154 transmits various types of information to another information processor such as the terminal device 10 or the voice recognition server. The transmission unit 154 transmits information stored in the storage unit 14.

The transmission unit 154 transmits various types of information on the basis of information from another information processor such as the information processor 100 or the voice recognition server. The transmission unit 154 transmits various types of information on the basis of the information stored in the storage unit 14.

In the example in FIG. 1, the transmission unit 154 transmits, to the information processor 100, information input by the user U1 in the content CT11. The transmission unit 154 transmits, to the information processor 100, the information indicating the answer “No, this is the first time” input by the user U1 and the information indicating the comment “I see”. The transmission unit 154 transmits, to the information processor 100, the meta-information such as the age and gender of the user U1.

The display unit 16 is provided in the terminal device 10 and displays various types of information. The display unit 16 is realized by, for example, a liquid crystal display, an organic electro-luminescence (EL) display, or the like. The display unit 16 may be realized by any means as long as the information provided from the information processor 100 can be displayed. The display unit 16 displays various types of information according to the control by the display control unit 152.

In the example in FIG. 1, the display unit 16 displays the content CT11.

### 1-5. Procedure of Information Processing According to Embodiment

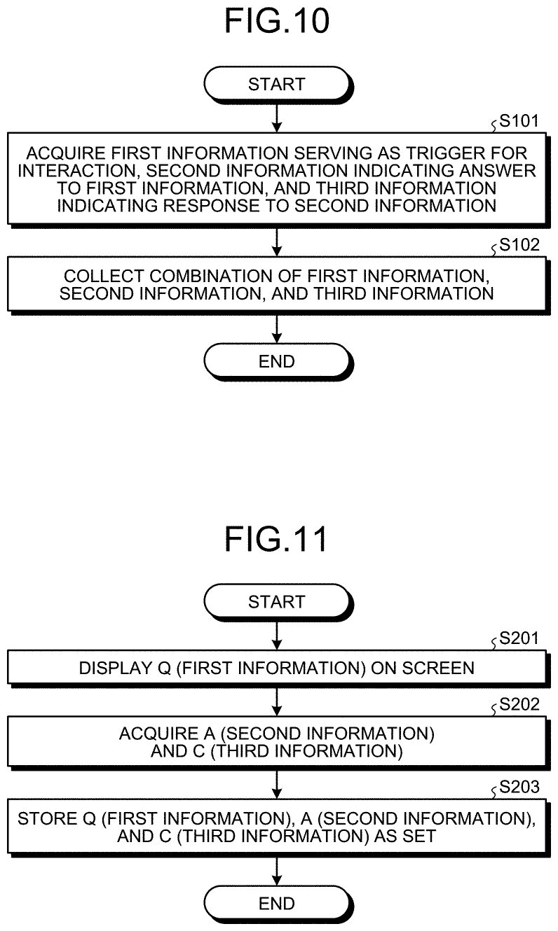

Next, a procedure of various types of information processing according to the embodiment will be described with reference to FIG. 10 to FIG. 12.

[1-5-1. Procedure of Collection Processing According to Information Processor]

First, a flow of information processing according to the embodiment of the present disclosure will be described with reference to FIG. 10. FIG. 10 is a flowchart illustrating the procedure of information processing according to the embodiment of the present disclosure. Specifically, FIG. 10 is the flowchart illustrating a procedure of collection processing by the information processor 100.

As illustrated in FIG. 10, the information processor 100 acquires the first information serving as the trigger for interaction, the second information indicating the answer to the first information, and the third information indicating the response to the second information (Step S101). The information processor 100 acquires the first information that is the question, the second information that is the answer to the question, and the third information that is the comment on the answer.

The information processor 100 collects a combination of the first information, the second information, and the third information (Step S102). The information processor 100 stores the combination (QAC triple) of the first information that is the question, the second information that is the answer to the question, and the third information that is the comment on the answer in the combination information storage unit 122 to collect the QAC triples.

[1-5-2. Procedure of Collection Processing According to Information Processing System]

Next, a flow of information processing according to the embodiment of the present disclosure will be described with reference to FIG. 11. FIG. 11 is a flowchart illustrating the procedure of information processing according to the embodiment of the present disclosure. Specifically, FIG. 11 is a flowchart illustrating a procedure of collection processing by the information processing system 1. Note that a process in each step may be performed by any device included in the information processing system 1, such as the information processor 100 or the terminal device 10.

As illustrated in FIG. 11, the information processing system 1 displays Q (first information) on the screen (Step S201). For example, the terminal device 10 displays the content CT11 including the question Q (first information) on the display unit 16. The Q (first information) displayed by the terminal device 10 may be randomly selected from a set of Qs (first information) prepared in advance, or may be selected according to a certain priority. For example, the information processor 100 may select Q (first information) to be presented to the user from the set of Qs (first information) stored in the first information storage unit 121 (see FIG. 4) and provide the Q to the user. For example, the information processor 100 selects one piece of the first information on the basis of the priority from the set of Qs (first information) stored in the first information storage unit 121 (see FIG. 4), and transmits the selected first information to the terminal device 10. Furthermore, in a case where the user performs an operation to skip the answer, the terminal device 10 may display a different Q (first information).

The information processing system 1 acquires A (second information) and C (third information) (Step S202). For example, the terminal device 10 acquires A (second information) that is the answer to the question input by the user and C (third information) that is the response on the answer. Furthermore, the information processor 100 acquires A (second information) that is the answer to the question input by the user, and C (third information) that is the response on the answer from the terminal device 10. The information processor 100 acquires, from the terminal device 10, A (second information) and C (third information) input by the data input person on the screen (display unit 16) of the terminal device 10.

The information processing system 1 stores Q (first information), A (second information), and C (third information) as a set (Step S203). The information processor 100 stores, in the storage unit 120, the combination of Q (first information) that is the question presented to the user, A (second information) that is the answer to the question input by the user, and C (third information) that is the response to the answer. The information processor 100 stores Q (first information) displayed on the screen of the terminal device 10 and A (second information) and C (third information) input on the screen of the terminal device 10 by the data input person as one set (QAC triple) in the database.

[1-5-3. Procedure of Generation Processing According to Information Processor]

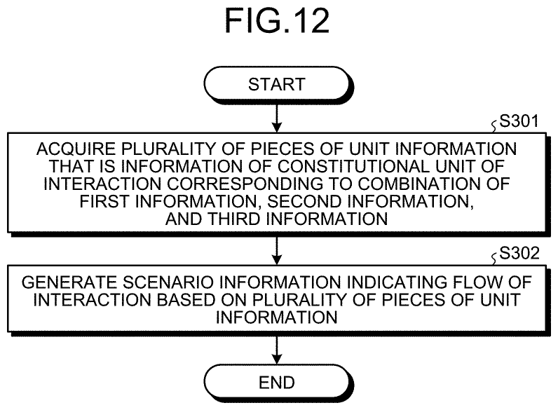

Next, generation processing of the scenario information according to the embodiment of the present disclosure will be described with reference to FIG. 12. FIG. 12 is a flowchart illustrating the procedure of generating the scenario according to the embodiment of the present disclosure. Specifically, FIG. 12 is a flowchart illustrating the procedure of generating scenario information by the information processor 100.

As illustrated in FIG. 12, the information processor 100 acquires the plurality of pieces of unit information that is information of the interaction constituent unit corresponding to the combination of the first information, the second information, and the third information (Step S301). For example, the information processor 100 acquires the plurality of pieces of unit information of the constituent unit that is the combination (QAC triple) of the first information, the second information, and the third information. For example, the information processor 100 acquires the plurality of pieces of unit information of the constituent unit that is each of the first information, the second information, and the third information.

Then, the information processing system 1 generates the scenario information indicating the flow of interaction on the basis of the plurality of pieces of unit information (Step S302). For example, the information processor 100 combines the plurality of combinations (QAC triples) that is the plurality of pieces of unit information, so as to generate the scenario information indicating the flow of interaction. For example, the information processor 100 generates the scenario information including a branch from one piece of the first information by associating the one piece of the first information with a plurality of pieces of the second information corresponding to the one piece of first information that is the unit information. For example, the information processor 100 generates the scenario information including a branch from one piece of the first information by associating the one piece of the first information with a plurality of second groups into which the plurality of pieces of the second information corresponding to the one piece of the first information that is the unit information is classified.

### 1-6. Storage Example of Combination (QAC Triple)

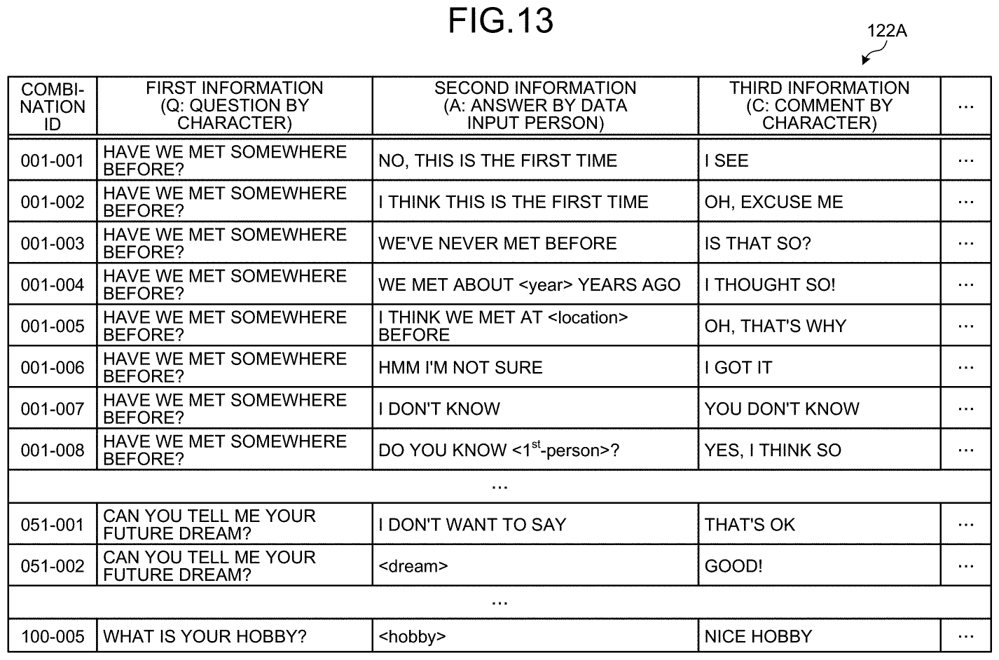

Here, the storage of the combination (QAC triple) of the first information (question), the second information (answer), and the third information (response) is not limited to the example illustrated in FIG. 1 and FIG. 5, and may be in various modes. This point will be described with reference to FIG. 13. Note that description of the same points as those in FIG. 5 will be omitted.

FIG. 13 is a diagram illustrating another example of the combination information storage unit. The information processor 100 may store information (expression) of the combination (QAC triple) of the first information (question), the second information (answer), and the third information (response) as a variable. A combination information storage unit 122A stores various types of information regarding the collected combinations. The combination information storage unit 122A illustrated in FIG. 13 includes items such as a “combination ID”, “first information (Q: Question by character)”, “second information (A: Answer by data input person)”, and “third information (C: Comment by character)”.

As illustrated in the combination information storage unit 122A, the information processor 100 may generalize collected data and store the data in the combination information storage unit 122A. In order to generalize the collected data, the information processor 100 may convert unique expressions (personal name, place name, date and time, quantity, and the like), personal pronouns (I, you, and the like), predetermined keywords, and the like to variables and then store the variables. For example, the information processor 100 may store keywords indicating hobby after converting the keywords to a variable.

In the example in FIG. 13, the combination (QAC triple) identified by a combination ID “001-004” indicates that the first information is “Have we met somewhere before?”, the second information is “We met about <year> years ago”, and the third information is “That's it!”. As described above, the example in FIG. 13 illustrates the case where an expression (character string) indicating a specific number of years in the second information is converted into a variable “<year>” and stored.

In addition, the combination (QAC triple) identified by a combination ID “100-005” indicates that the first information is “What is your hobby?”, the second information is “<hobby>”, and the third information is “Nice hobby”. As described above, the example in FIG. 13 illustrates the case where a keyword (character string) indicating a specific hobby in the second information is converted into a variable “<hobby>” and stored.

### 1-7. Processing Using Combination (QAC Triple)

Processing using the combination (QAC triple) collected will be described below.

[1-7-1. Generation of Scenario Information]

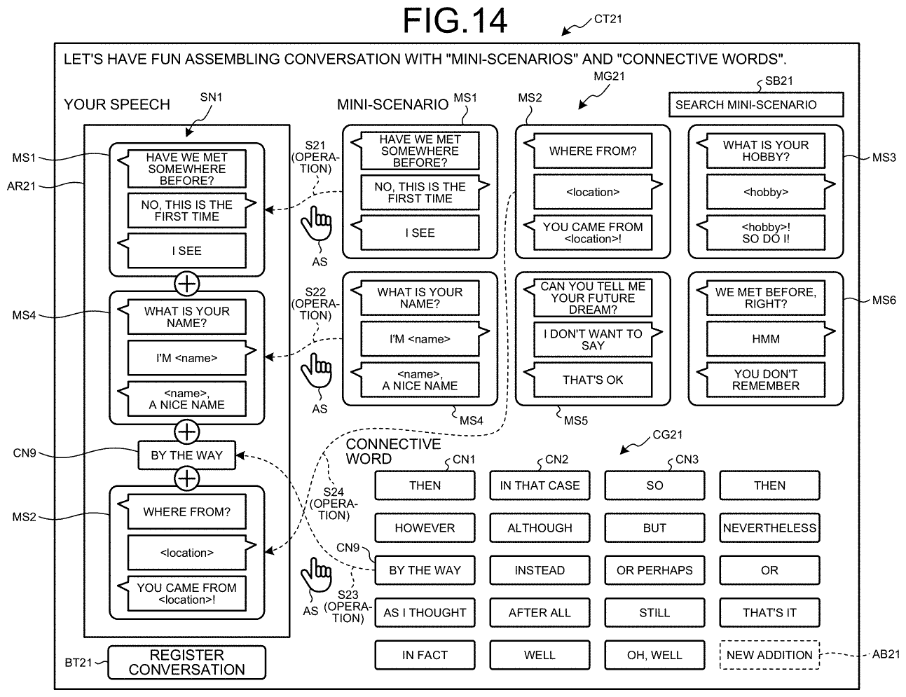

First, generation of the scenario information will be described with reference to FIG. 14 and FIG. 15. FIG. 14 and FIG. 15 are diagrams illustrating an example of generation of the scenario information. For example, FIG. 14 illustrates an example of an execution screen of a “scenario puzzle” for creating an interaction sequence. For example, FIG. 15 illustrates an example of creation of interaction sequence data using the scenario puzzle.

Here, the scenario puzzle refers to a game to enjoy constructing various conversation flows by combining “mini-scenarios” (collected QAC triples). By having the user play with this puzzle, a meaningful conversation flow (interaction sequence) can be collected. For example, the scenario puzzle execution screen includes options (mini-scenario group MG21, etc.) of the QAC triples (mini-scenarios), a form for building the scenario puzzle (assembly region AR21, etc.), and a button for transmitting input information (registration button BT21, etc.). Furthermore, the scenario puzzle execution screen may include an option (connective word group CG21 or the like) of “connective words” (conjunctions or the like) used for connection of the mini-scenarios, a button (new addition button AB21 or the like) for newly adding an arbitrary connective word, and a search box (search window SB21 or the like) for performing keyword search for the mini-scenario. Hereinafter, a more detailed description will be given with reference to FIG. 14.

As illustrated in FIG. 14, the information processing system 1 may generate the scenario information by using the information acquired by a content CT21 that is the scenario puzzle execution screen. For example, the information processor 100 transmits the content CT21 to the terminal device 10, and acquires, from the terminal device 10, information input by the user in the content CT21 displayed on the terminal device 10. The information processor 100 generates the scenario information by using the information acquired from the terminal device 10.

In the content CT21, the mini-scenario group MG21 including mini-scenarios MS1 to MS6 and the like is arranged. Individual mini-scenarios MS1 to MS6 correspond to each of the collected QAC triples. For example, the mini-scenario MS1 corresponds to the combination (QAC triple) identified by the combination ID “001-001” in the combination information storage unit 122 (see FIG. 4) or the combination information storage unit 122A (see FIG. 13). Note that, the example in FIG. 14 illustrates a case where six mini-scenarios of the mini-scenarios MS1 to MS6 are arranged. However, the number is not limited to six, and for example, various number of mini-scenarios, such as 3 or 10 mini-scenarios, may be arranged.

Further, the mini-scenario included in the content CT21 may be randomly selected, or the user may be able to search for a mini-scenario that the user wants. In the example in FIG. 14, the search window SB21 for searching the mini-scenario is arranged in the content CT21. The user can search for the mini-scenario by inputting a keyword (query) in the search window SB21. For example, when a keyword (query) is input in the search window SB21, the terminal device 10 transmits the input query to the information processor 100. The information processor 100 receiving the query searches for the combination (QAC triple), using the query, in the combination information storage unit 122 (see FIG. 4) or the combination information storage unit 122A (see FIG. 13). Then, the information processor 100 transmits the combination (QAC triple) extracted by search to the terminal device 10 as a mini-scenario corresponding to the query. Then, the terminal device 10 displays the received mini-scenario.

In addition, a connective word group CG21 including connective words CN1 to CN3, CN9, and the like between the combinations (QAC triples) is arranged in the content CT21. The connective words CN1 to CN3, CN9, and the like are, for example, information on connection between the combinations (QAC triples) such as conjunctions. Note that the example in FIG. 14 illustrates a case where 19 connective words, such as CN1 to CN3 and CN9, are arranged, but the number is not limited to 19, and various connective words such as 15 or 30 words may be arranged.

In addition, the new addition button AB21 for adding a new connective word is arranged in the content CT21. The new addition button AB21 is described as “newly add”, and when the user cannot find an appropriate connective word, the user can newly add a connective word by selecting the new addition button AB21.

In addition, the assembly region AR21 in the content CT21 is a region in which the mini-scenario and the connective word are arranged according to an operation by the user, and a conversation assembled according to designation by the user is displayed. A character string “your conversation” is arranged in an upper part of the assembly region AR21 to indicate that the assembly region AR21 is a region used by the user to assemble a conversation. For example, the user arranges the mini-scenarios and the connective word in the assembly region AR21 by various operations such as drag & drop to assemble the conversation.

In addition, the content CT21 includes a registration button BT21 indicated with a character string “Register conversation”. For example, when the user presses the registration button BT21 in the content CT21 displayed on the terminal device 10, information or the like input by the user in the content CT21 is transmitted to the information processor 100. For example, when the user presses the registration button BT21, information indicating the conversation assembled in the assembly region AR21 is transmitted to the information processor 100.

In addition, the content CT21 includes a character string such as “Let's have fun assembling a conversation with “mini-scenarios” and “connective words””. As a result, the content CT21 prompts the user to build a conversation using the mini-scenario and the connective word.

In the example in FIG. 14, the user performs an operation of arranging the mini-scenario MS1 in the assembly region AR21 (Step S21). The user designates the mini-scenario MS1 by an instruction means AS such as a finger of the user's hand, and moves the designated mini-scenario MS1 to the assembly region AR21. Note that the instruction means AS is not limited to a hand or a finger, and may be a predetermined instruction object such as a pen held by the user's hand, eye contact, voice, or the like. In addition, the user may designate the mini-scenario MS1 using a mouse to move the designated mini-scenario MS1 to the assembly region AR21. For example, the user performs an operation of moving the mini-scenario MS1 to the assembly region AR21 by the drag & drop operation. As a result, the mini-scenario MS1 is arranged in the assembly region AR21.

Then, the user performs an operation of arranging the mini-scenario MS4 in the assembly region AR21 (Step S22). Specifically, the user performs an operation of arranging the mini-scenario MS4 under the mini-scenario MS1 in the assembly region AR21. The user designates the mini-scenario MS4 by the instruction means AS, and moves the designated mini-scenario MS4 to a position below the mini-scenario MS1 in the assembly region AR21. For example, the user performs the operation of moving the mini-scenario MS4 to the assembly region AR21 by the drag & drop operation. As a result, the mini-scenario MS1 is arranged at a position below the mini-scenario MS1 in the assembly region AR21.

Then, the user performs an operation of arranging the connective word CN9 in the assembly region AR21 (Step S23). Specifically, the user performs an operation of arranging the connective word CN9 that is a conjunction “by the way” under the mini-scenario MS4 in the assembly region AR21. The user designates the connective word CN9 by the instruction means AS and moves the designated connective word CN9 to a position below the mini-scenario MS4 in the assembly region AR21. For example, the user performs the operation of moving the connective word CN9 to the assembly region AR21 by the drag & drop operation. As a result, the connective word CN9 is arranged at a position below the mini-scenario MS4 in the assembly region AR21.

Then, the user performs an operation of arranging the mini-scenario MS2 in the assembly region AR21 (Step S24). Specifically, the user performs an operation of arranging the mini-scenario MS2 under the connective word CN9 in the assembly region AR21. The user designates the mini-scenario MS2 by the instruction means AS, and moves the designated mini-scenario MS2 to a position below the connective word CN9 in the assembly region AR21. For example, the user performs the operation of moving the mini-scenario MS2 to the assembly region AR21 by the drag & drop operation. As a result, the connective word CN9 is arranged at a position below the connective word CN9 in the assembly region AR21.

By the above-described operation, the user assembles the scenario SN1 in which the mini-scenario MS1, the mini-scenario MS4, the connective word CN9, and the mini-scenario MS2 are arranged in this order in the assembly region AR21.

Then, in response to the pressing of the registration button BT21 by the user, the terminal device 10 transmits the information input in the content CT21 by the user to the information processor 100. In the example in FIG. 14, the terminal device 10 transmits, to the information processor 100, information indicating the scenario SN1 in which the mini-scenario MS1, the mini-scenario MS4, the connective word CN9, and the mini-scenario MS2 are arranged in this order. Note that the terminal device 10 may transmit the meta-information such as the age and gender of the user to the information processor 100 together with the information input in the content CT21 by the user. In this case, the information processor 100 stores the mini-scenarios, the connective word, and the user meta-information in association with each other.

Then, the information processor 100 generates the scenario information as illustrated in FIG. 15 by using the information acquired from the terminal device 10 (Step S31). The information processor 100 generates the scenario information on the basis of the information arranged in the order of the mini-scenario MS1, the mini-scenario MS4, the connective word CN9, and the mini-scenario MS2. For example, the information processor 100 generates the scenario information by associating each utterance included in the mini-scenario MS1, each utterance included in the mini-scenario MS4, the connective word CN9, and each utterance included in the mini-scenario MS2 with one scenario ID “SN1”. The information processor 100 generates the scenario information in which the mini-scenario MS1, the mini-scenario MS4, the connective word CN9, and the mini-scenario MS2 are arranged in this order.

Then, the information processor 100 stores the generated scenario information (Step S32). The information processor 100 stores the scenario information in the scenario information storage unit 124. The information processor 100 stores, in the scenario information storage unit 124, each utterance included in the mini-scenario MS1, each utterance included in the mini-scenario MS4, the connective word CN9, and each utterance included in the mini-scenario MS2 in association with one scenario ID “SN1”.

In the conventional method, it is only a collection of a set of one question and one answer (QA pair), and thus, it is difficult to create coherent natural conversation scenario data using collected data. Furthermore, in order to realize a natural “flow of interaction”, a flow of response in an interaction unit, an overall flow of conversation topic when a plurality of interaction units is combined, and a conjunction that smoothly connects the plurality of interaction units are required. Therefore, in the conventional method, it is difficult to create coherent natural conversation scenario data.

On the other hand, in the information processing system 1, the triples of “question (Q) by character”, “answer (A) by user”, and “comment (C) by character on user's answer A” are collected, so that it is possible to collect conversation scenario data with natural flow of response. In addition, the information processing system 1 makes it possible to easily collect and create the conversation scenario data by combining a plurality of combinations (QAC triples) and an appropriate conjunction so that the flow of interaction becomes natural. In this manner, the information processor 100 can acquire information for constructing the interaction system. The information processor 100 can appropriately generate one conversation scenario by handling the collected data of the combination (QAC triple) as one interaction unit (mini-scenario) and having the user connect a plurality of mini-scenarios displayed using a connective word such as a conjunction. In addition, the information processor 100 stores a chain of mini-scenarios and connective words and meta-information of the user who has created the chain in association with each other. As a result, the information processor 100 can construct the interaction system according to the attribute or the like of the user.

Furthermore, as illustrated in FIG. 15, the information processing system 1 uses the chain of mini-scenarios and connective word created by the scenario puzzle as it is as the interaction sequence. The information processing system 1 can use the interaction sequence as development and evaluation data for the interaction system (a computer system capable of having a conversation with a human).

As described above, in the information processing system 1, the generated interaction sequence can be used for model construction in the interaction system. For example, unlike a reply chain in Twitter (registered trademark) or a script of a movie, the information processing system 1 can construct the interaction system using various interaction sequences based on a free idea of the user.

[1-7-2. Conversation Relation Recognition]

Next, conversation relation recognition will be described with reference to FIG. 16. FIG. 16 is a diagram illustrating an example of conversation relation recognition. For example, FIG. 16 illustrates an example of using results of the scenario puzzle.

In the example in FIG. 16, the information processor 100 performs conversation relation recognition using the information indicating the scenario SN2 arranged in the order of the mini-scenario MS1, the connective word CN7, and a mini-scenario MS6 (Step S41). In other words, the information processor 100 determines the conversation relation between the mini-scenario MS1 and the mini-scenario MS6 on the basis of information of the connective word CN7 that is the conjunction “but”. The information processor 100 determines the relationship between the mini-scenario MS1 and the mini-scenario MS6 connected by the connective word CN7 on the basis of the information of the connective word CN7 that is the conjunction “but”. In the example in FIG. 16, the information processor 100 determines that the conversation relationship between the mini-scenario MS1 and the mini-scenario MS6 is “contrast” as indicated by determination information DR41.

For example, the information processor 100 determines that the conversation relationship between the mini-scenario MS1 and the mini-scenario MS6 is “contrast” by using information indicating that the function of the connective word CN7 that is the conjunction “but” has the function of “contrast”. The information processor 100 determines that the conversation relationship between the mini-scenario MS1 and the mini-scenario MS6 is “contrast” by using the information indicating the function of each connective word. For example, the information processor 100 determines that the conversation relationship between the mini-scenario MS1 and the mini-scenario MS6 is “contrast” by using the information indicating that the function of the connective word CN7 stored in the connection information storage unit 123 (see FIG. 6) has the function of “contrast”.

In this way, the result of the scenario puzzle can be utilized as learning and evaluation data for recognizing the conversation relationship. Normally, in a case where an expert is employed, labeling of a conversation relationship requires a high cost, but in the information processing system 1, an increase in cost can be suppressed by using information of a connective word (conjunction) selected by the user (non-expert).

### 1-8. Model Learning

A model may be learned using the collected combinations (QAC triples). This point will be described with reference to FIG. 17 to FIG. 20. FIG. 17 is a diagram illustrating an example of model learning of conjunction estimation. FIG. 18 is a diagram illustrating an example of model learning of conversation relation recognition. FIG. 19 is a diagram illustrating an example of model learning of next mini-scenario estimation based on conjunction. FIG. 20 is a diagram illustrating an example of a network corresponding to a model according to the embodiment of the present disclosure.

[1-8-1. Model Learning of Conjunction Estimation]

First, model learning of conjunction estimation will be described with reference to FIG. 17. As illustrated in FIG. 17, the information processor 100 learns a model M1 that uses two mini-scenarios (QAC triples) of a first mini-scenario IN51 and a second mini-scenario IN52 as inputs, and outputs information OT51 indicating a conjunction that is entered between the two mini-scenarios. The information processor 100 uses two mini-scenarios (QAC triples) as inputs, and learns the model M1 for estimating a conjunction to enter between the two mini-scenarios.

For example, the information processor 100 learns the model M1 by using information as illustrated in FIG. 15 and FIG. 16. For example, the information processor 100 generates the model M1 by learning the learning data in which the mini-scenario MS1 and the mini-scenario MS6 illustrated in FIG. 16 are input data and the connective word CN7 is correct answer data. When the mini-scenario MS1 and the mini-scenario MS6 are input, the information processor 100 generates the model M1 by learning so that information indicating the connective word CN7 is output. For example, in a case where the mini-scenario MS1 and the mini-scenario MS6 are input, the information processor 100 generates the model M1 that outputs information indicating the conjunction “but”. Furthermore, the information processor 100 may generate the model M1 that outputs information indicating the function of conjunction “contrast” in a case where the mini-scenario MS1 and the mini-scenario MS6 are input.

In addition, for example, the information processor 100 generates the model M1 by learning the learning data in which the mini-scenario MS1 and the mini-scenario MS2 illustrated in FIG. 15 are input data and the connective word unnecessary (for example, a predetermined value such as “NULL”) is correct answer data. When the mini-scenario MS1 and the mini-scenario MS2 are input, the information processor 100 generates the model M1 by learning so that information indicating that the connective word is unnecessary is output.

As a result, the information processor 100 can generate a model for estimating which connective word (conjunction or the like) should be entered or the connective word should not be entered between mini-scenarios (conversation pieces). By using the generated model, the information processor 100 can appropriately estimate which connective word (conjunction or the like) should be entered or the connective word should not be entered between mini-scenarios (conversation pieces).

[1-8-2. Model Learning of Conversation Relation Recognition]

Next, model learning of conversation relation recognition will be described with reference to FIG. 18. As illustrated in FIG. 18, the information processor 100 learns a model M2 that uses two mini-scenarios (QAC triples) of a first mini-scenario IN53 and a second mini-scenario IN54 as inputs, and outputs information OT52 indicating conversation relation recognition between the two mini-scenarios. The information processor 100 uses two mini-scenarios (QAC triples) as inputs, and learns the model M2 for estimating (recognizing) a conversation relationship between the two mini-scenarios.

For example, the information processor 100 learns the model M2 by using the information illustrated in FIG. 15 and FIG. 16. For example, the information processor 100 generates the model M2 by learning the learning data in which the mini-scenario MS1 and the mini-scenario MS6 illustrated in FIG. 16 are input data and the conversation relationship “contrast” is correct answer data. In a case where the mini-scenario MS1 and the mini-scenario MS6 are input, the information processor 100 generates the model M2 by learning so that information indicating the conversation relationship “contrast” is output.

As a result, the information processor 100 can generate a model for estimating a conversation relationship (contrast, reason, purpose, condition, and the like) between mini-scenarios (conversation pieces). The information processor 100 can appropriately estimate the conversation relationship (contrast, reason, purpose, condition, and the like) between the mini-scenarios (conversation pieces) by using the generated model.

[1-8-3. Model Learning of Next Mini-Scenario Estimation Based on Conjunction]

Next, model learning of conversation relation recognition will be described with reference to FIG. 19. As illustrated in FIG. 19, the information processor 100 learns a model M3 that uses a mini-scenario IN55 and a conjunction IN56 after the mini-scenario as inputs, and outputs information OT53 indicating a mini-scenario (next mini-scenario) after the mini-scenario IN55 and the conjunction IN56. The information processor 100 learns the model M3 that outputs candidates of the next mini-scenario. The information processor 100 uses one mini-scenario (QAC triple) and a conjunction (connective word) following the mini-scenario as inputs, and learns the model M3 for estimating a candidate of the next mini-scenario following the conjunction (connective word).

For example, the information processor 100 learns the model M3 by using the information illustrated in FIG. 15 and FIG. 16. For example, the information processor 100 generates the model M3 by learning the learning data in which the mini-scenario MS1 and the connective word CN7 illustrated in FIG. 16 are input data and the mini-scenario MS6 is correct answer data. When the mini-scenario MS1 and the connective word CN7 are input, the information processor 100 generates the model M3 by learning so that information indicating the mini-scenario MS6 is output.

As a result, the information processor 100 can generate a model for estimating an appropriate next scenario by giving a pair of the mini-scenario and the conjunction. The information processor 100 can appropriately estimate an appropriate next scenario by using the generated model that provides the pair of the mini-scenario and the conjunction.

As described above, the information processor 100 generates various models such as the models M1 to M3 by using data such as which mini-scenario (QAC triple) and a connective word have been used to construct the generated scenario (scenario information). Then, the information processor 100 can appropriately generate various types of information for constructing the interaction system by using the models generated by machine learning. In this manner, the information processor 100 can generate an appropriate scenario from a set of mini-scenarios by applying machine learning using the information regarding the generated scenario (scenario information).

[1-8-4. Network Example]

The models M1 to M3 in FIG. 17 to FIG. 19 described above may be configured by various networks. For example, the models M1 to M3 may be any type of model (learning device) such as a regression model including a support vector machine (SVM) or a neural network. For example, the models M1 to M3 may be various regression models such as a nonlinear regression model and a linear regression model.

In this regard, an example of a network of the model to be learned will be described with reference to FIG. 20. FIG. 20 is a diagram illustrating an example of a network corresponding to a model according to the embodiment of the present disclosure. FIG. 20 is a conceptual diagram illustrating an example of a network of models to be learned. The network NW1 in FIG. 20 illustrates a neural network including a plurality of (multilayer) intermediate layers between an input layer INL and an output layer OUTL. Hereinafter, using the model M1 as an example, a case where the information processor 100 estimates a conjunction that is used between two mini-scenarios using the model M1 corresponding to the network NW1 illustrated in FIG. 20 will be described.

The network NW1 illustrated in FIG. 20 is a conceptual diagram in which a function that corresponds to a function that estimates a conjunction to enter between two mini-scenarios and estimates a conjunction to enter between two mini-scenarios is expressed as a neural network (model). For example, the input layer INL in the network NW1 includes network elements (neurons) corresponding to two mini-scenarios serving as inputs, respectively. In addition, the output layer OUTL in the network NW1 includes a network element (neuron) corresponding to a conjunction to enter between the two input mini-scenarios.

Note that the network NW1 illustrated in FIG. 20 is merely an example of a model network, and any network configuration is acceptable as long as a desired function can be realized. For example, the example in FIG. 20 illustrates a case where the number of network elements (neurons) in the output layer OUTL is one for ease of description. However, for example, in a case of a classification model, the number of network elements (neurons) in the output layer OUTL may be plural (for example, the number of classes to be classified).

Furthermore, the information processor 100 may generate a model corresponding to the network NW1 illustrated in FIG. 20 by performing the learning process on the basis of various learning methods. The information processor 100 may generate a certainty factor model by performing the learning process on the basis of a method related to machine learning. Note that the above is an example, and the information processor 100 may generate the model by any learning method as long as the model corresponding to the network NW1 illustrated in FIG. 20 can be generated.

### 1-9. Configuration of Information Processor According to Modification

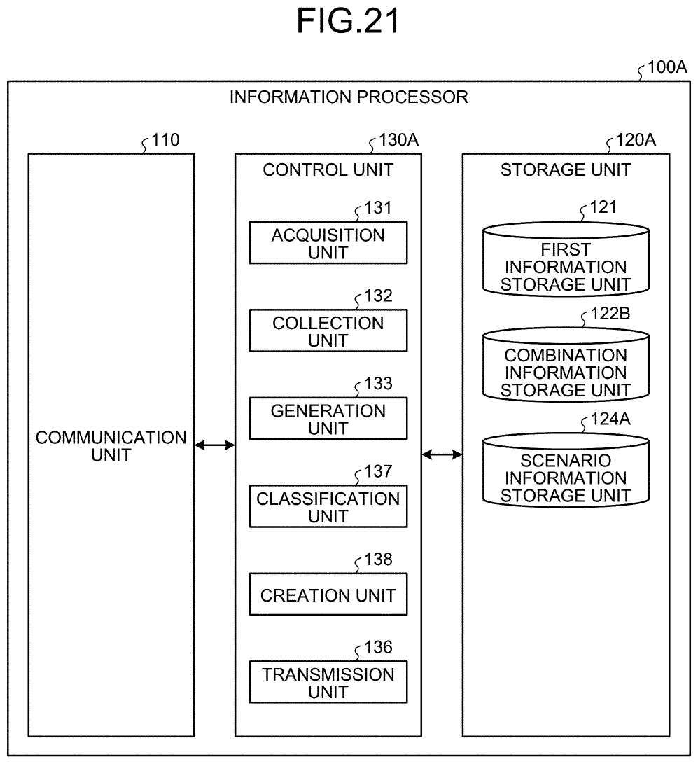

Note that the processing using the collected combinations (QAC triples) is not limited to the above, and may be in various modes. For example, a branch scenario may be generated as the scenario information by using the collected combinations (QAC triples). This point will be described with reference to FIG. 21. FIG. 21 is a diagram illustrating a configuration example of an information processor according to a modification of the present disclosure.

Note that description of points similar to those in the embodiment will be omitted as appropriate. For example, collection of the combinations (QAC triples) is similar to that of the embodiment, and thus description thereof is omitted. Furthermore, for example, the information processing system 1 according to the modification includes an information processor 100A instead of the information processor 100. In other words, the information processing system 1 according to the modification includes the terminal device 10 and the information processor 100A.

First, a configuration of the information processor according to the modification will be described. As illustrated in FIG. 21, the information processor 100A includes the communication unit 110, a storage unit 120A, and a control unit 130A.

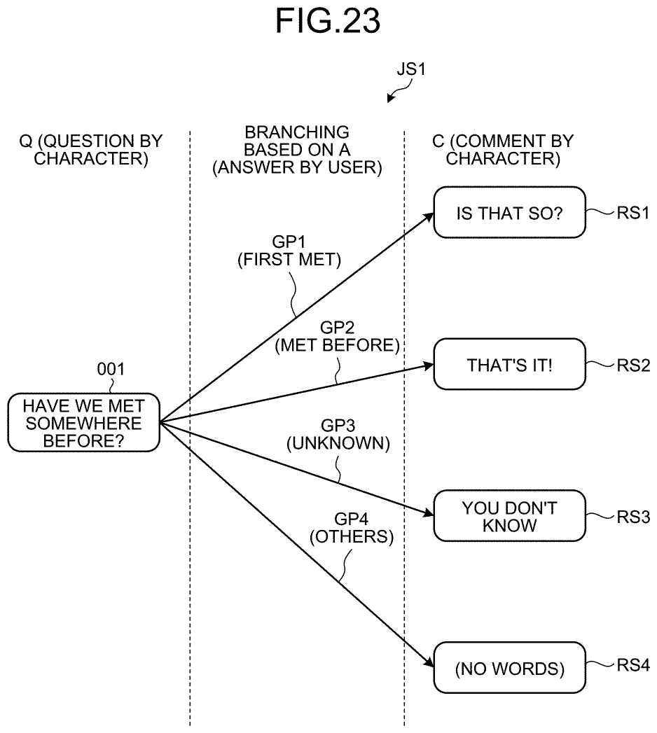

The storage unit 120A is realized by, for example, a semiconductor memory element such as a RAM or a flash memory, or a storage device such as a hard disk or an optical disk. As illustrated in FIG. 21, the storage unit 120A according to the modification includes the first information storage unit 121, a combination information storage unit 122B, and a scenario information storage unit 124A. Although not illustrated, the scenario information storage unit 124A stores various types of scenario information such as information on a branch scenario as illustrated in FIG. 23.

The combination information storage unit 122B according to the modification stores the combinations (QAC triples) of the first information (question), the second information (answer), and the third information (response) in association with information for classifying each combination (QAC triple). For example, the combination information storage unit 122B stores information obtained by classifying each combination (QAC triple) according to the first information (question) and the second information (answer) in association with each combination (QAC triple).

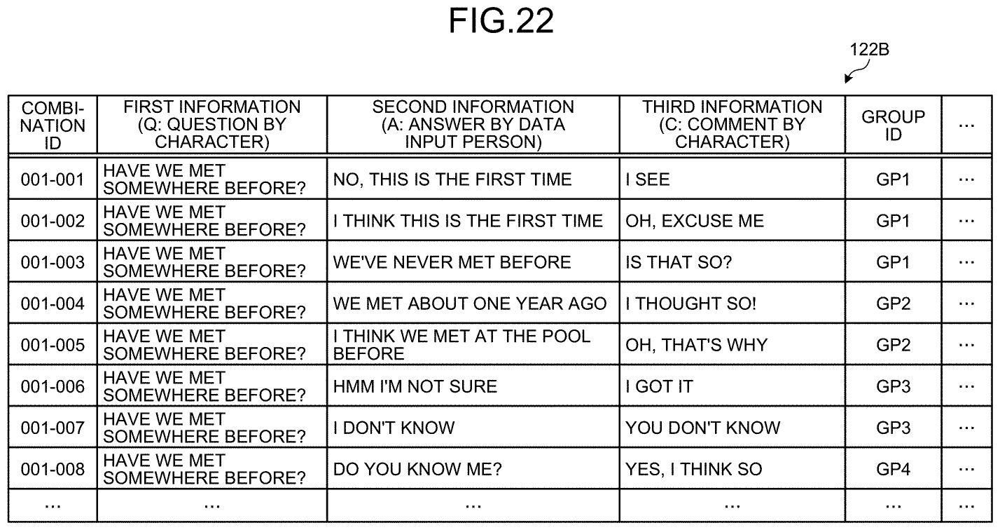

The combination information storage unit 122B stores various types of information regarding the collected combinations. The combination information storage unit 122B illustrated in FIG. 22 includes items such as the “combination ID”, the “first information (Q: Question by character)”, the “second information (A: Answer by data input person)”, and the “third information (C: Comment by character)”, and the “group ID”. As described above, the combination information storage unit 122B includes the item “group ID”. The “group ID” indicates the classification of each combination (QAC triple). As described above, the combination information storage unit 122B stores the information indicating a classification result of the QAC triple (group ID) in association with each QAC triple.

In the example in FIG. 22, the combination (QAC triple) identified by the combination ID “001-001” indicates that the first information is “Have we met somewhere before?”, the second information is “No, this is the first time”, and the third information is “I see”. The combination (QAC triple) identified by the combination ID “001-001” indicates that the combination belongs to the group identified by the group ID “GP1”.

In addition, the combination (QAC triple) identified by a combination ID “001-002” indicates that the first information is “Have we met somewhere before?”, the second information is “I think this is the first time”, and the third information is “Oh, excuse me”. The combination (QAC triple) identified by the combination ID “001-002” indicates that the combination belongs to the group identified by the group ID “GP1”.

Note that the above is an example, and the combination information storage unit 122B is not limited to the above, and may store various types of information depending on the purpose.

Returning to FIG. 21, the description will be continued. The control unit 130A is realized by, for example, a CPU, an MPU, or the like that executes a program (for example, an information processing program or the like according to the present disclosure) stored inside the information processor 100A using a RAM or the like as a work area. Furthermore, the control unit 130A is a controller, and is realized by, for example, an integrated circuit such as an ASIC or an FPGA.

As illustrated in FIG. 21, the control unit 130A includes the acquisition unit 131, the collection unit 132, the generation unit 133, the transmission unit 136, a classification unit 137, and a creation unit 138, and realizes or executes functions and actions of information processing described below. Note that the internal configuration of the control unit 130A is not limited to the configuration illustrated in FIG. 21, and may be another configuration as long as information processing to be described later is performed. Furthermore, the connection relationship among the processing units included in the control unit 130A is not limited to the connection relationship illustrated in FIG. 21, and may be another connection relationship.

The classification unit 137 classifies various types of information. The classification unit 137 generates information indicating various types of classification. The classification unit 137 classifies various types of information on the basis of information from an external information processor or information stored in the storage unit 120A. The classification unit 137 classifies various types of information on the basis of information from another information processor such as the terminal device 10 or the voice recognition server. The classification unit 137 classifies various types of information on the basis of information stored in the first information storage unit 121, the combination information storage unit 122B, and the scenario information storage unit 124A.

The classification unit 137 classifies the combinations (QAC triples) of the first information (Q), the second information (A), and the third information (C) collected by the collection unit 132 by grouping A to each Q. The classification unit 137 automatically groups A to each Q by using the collected Q-A-C triplets (QAC triples) data and the user's meta information, thereby classifying the combinations (QAC triples).

The classification unit 137 performs classification using various conventional techniques as appropriate. The classification unit 137 performs classification using a conventional technique related to clustering as appropriate.

For example, the classification unit 137 vectorizes the second information (A) included in each QAC triple, and clusters the second information (A) based on the vector. For example, the classification unit 137 vectorizes the second information (A) included in each QAC triple having the same first information (Q), and clusters the second information (A) of each QAC triple having the same first information (Q) based on the vector.

Note that the method of vectorizing the second information (A) may be any method, such as bag-of-words or distributed expression, as long as the second information (A) is vectorized. In addition, the clustering method may be any method, such as k-means, as long as the second information (A) can be clustered.

The generation unit 133 associates a plurality of pieces of second information corresponding to one piece of first information or associates a plurality of second groups obtained by classifying a plurality of pieces of second information with one piece of first information, thereby generating the scenario information including a branch from the one piece of first information (also referred to as a branch scenario). For example, the generation unit 133 associates a plurality of groups obtained by classifying a plurality of answers (A) corresponding to one question (Q) with one question (Q) on the basis of the classification result by the classification unit 137, thereby generating a branch scenario including a branch from the one question (Q).

The generation unit 133 stores the generated scenario information in the storage unit 120A. The generation unit 133 stores the generated branch scenario in the storage unit 120A. The generation unit 133 stores information indicating a generated branch scenario JS1 in the storage unit 120A.

The creation unit 138 creates various types of information. The creation unit 138 generates various types of information. The creation unit 138 creates various types of information on the basis of information from an external information processor and information stored in the storage unit 120A. The creation unit 138 creates various types of information on the basis of information from another information processor such as the terminal device 10 or the voice recognition server. The creation unit 138 creates various types of information on the basis of the information stored in the first information storage unit 121, the combination information storage unit 122B, or the scenario information storage unit 124A.

The creation unit 138 creates the comment to be presented to the user on the basis of the answer by the user to whom the one piece of the first information is presented and the scenario information. The creation unit 138 creates the comment to be presented to the user on the basis of the classification by the classification unit 137. The creation unit 138 selects the comment to be presented to the user on the basis of classification by the classification unit 137. The creation unit 138 creates the comment to be presented to the user by using the branch scenario generated by the generation unit 133. The creation unit 138 selects the comment to be presented to the user by using the branch scenario generated by the generation unit 133.

The creation unit 138 estimates a type pattern (branch) of the second information (A) with respect to each piece of the first information (Q) on the basis of the classification by the classification unit 137. The creation unit 138 estimates the type pattern (branch) of the second information (A) with respect to each piece of the first information (Q) using the branch scenario generated by the generation unit 133. The creation unit 138 estimates the type pattern (branch) of the second information (A) with respect to each piece of the first information (Q) using the information indicating the branch scenario JS1 generated by the generation unit 133.

The creation unit 138 creates appropriate third information (C) with respect to the branch of the second information (A). The creation unit 138 selects appropriate third information (C) with respect to the branch of the second information (A). The creation unit 138 creates appropriate third information (C) with respect to the branch of the second information (A) by using the information indicating the branch scenario JS1 generated by the generation unit 133. The creation unit 138 selects appropriate third information (C) with respect to the branch of the second information (A) using the information indicating the branch scenario JS1 generated by the generation unit 133.

The creation unit 138 selects an answer from the third information (comment by character) belonging to each scenario branch (QAC triple group). For example, the creation unit 138 may randomly select one from the third information (C) belonging to each scenario branch (QAC triple group), or may select one by using another algorithm. For example, the creation unit 138 may select the third information (C) to be used as an answer on the basis of the information of each word constituting the third information (C). For example, the creation unit 138 may select the third information (C) using a feature amount such as tf-idf (importance of each word in the reply group with respect to the first information (Q)) of each word constituting the third information (C). For example, the creation unit 138 may select the third information (C) to be used in the conversation scenario by using machine learning. For example, the creation unit 138 may use machine learning with tf-idf (importance of each word in the reply group with respect to Q) of each word constituting the third information (C) as the feature amount to select the most suitable third information (C) to be used in the conversation scenario.

The creation unit 138 may determine, on the basis of various conditions, which branch (group) to classify the second information (answer) of the user to the first information (question), using the information of the branch scenario. For example, the creation unit 138 may determine to which group to classify the second information (answer) of the user by performing character string matching using various technologies, such as regular expression, as appropriate. For example, when the user's answer (utterance) includes a specific character string, the creation unit 138 may determine that the answer is applicable to a branch (group) corresponding to the specific character string. For example, the creation unit 138 may determine that the user's answer (utterance) is applicable to a branch (group) by using information in which each branch (group) is associated with a characteristic character string of each branch. For example, the creation unit 138 may associate a group GP1 with a character string indicating that the user has no acquaintance, such as “first time” or “never met”.

For example, the creation unit 138 may determine each group of QAC triples as one scenario branch so as to determine that the user's answer (utterance) is applicable to the corresponding branch (group). For example, the creation unit 138 determines, for each scenario branch (QAC triple group), a condition of utterance leading to the branch. For example, in a case where the user's answer (utterance) includes a word characteristic to the second information (A) belonging to a certain branch (group), the creation unit 138 may determine that the user's answer is applicable to that branch (group). For example, the creation unit 138 may determine to which branch (group) the user's answer is applicable by using a text division method such as N-gram. For example, in the case of the group GP1, when the user's answer includes a character string such as “first time” or “never met”, the creation unit 138 may determine that the user's answer is applicable to the group GP1. For example, for the group GP1, the creation unit 138 may determine to which branch (group) the user's answer is applicable by using a description of a regular expression indicating that the group GP1 includes the character string “first time” or “never met”.

### 1-10. Branch Scenario According to Modification

The information processor 100A creates the conversation scenario including a branch scenario. The conversation scenario mentioned here refers to, for example, a set of rules for the interaction system to answer to human (user) utterances. An interaction rule based on conditional branches can be considered. For example, when the user's answer to “Have we met somewhere before?” by the system conveys the meaning of “meeting for the first time”, the system returns “Is that so”, and when the user's answer conveys the meaning of “meeting before”, the system returns “That's it!”. The following describes details of conditional branches in the conversation scenario and a method of automatically creating a system answer in each conditional branch.

The branch scenario that is an example of the scenario information according to the modification will be described with reference to FIG. 22 and FIG. 23. FIG. 23 is a diagram illustrating an example of the branch scenario according to the modification. The information processor 100A creates the conversation scenario based on the QAC triple.

In FIG. 23, the information processor 100A classifies the combinations (QAC triples) in which the question “Have we met somewhere before?” identified by the first information ID “001” stored in the first information storage unit 121 (see FIG. 4) is set as the first information. The information processor 100A classifies the combinations (QAC triples) having the question “Have we met somewhere before?” stored in the combination information storage unit 122B in FIG. 22 as the first information. Specifically, the information processor 100A classifies eight QAC triples identified by the combination information IDs “001-001” to “001-008” stored in the combination information storage unit 122B in FIG. 22.

The information processor 100A classifies a plurality of QAC triples associated with the same first information (Q) according to the content of the second information (A), and constructs conditional branches of the conversation scenario on the basis of the classification (group). In the example in FIG. 23, the information processor 100A classifies the QAC triples with the question “Have we met somewhere before?” as the first information into four groups GP1 to GP4.

As illustrated in FIG. 22, the information processor 100A classifies QAC triples with the second information (A) “No, this is the first time”, “I think this is the first time”, and “We've never met before” into the group GP1. The information processor 100A classifies three QAC triples identified by the combination information IDs “001-001” to “001-003” into the group GP1 corresponding to a “group providing notification of meeting for the first time”.

Furthermore, as illustrated in FIG. 22, the information processor 100A classifies QAC triples with the second information (A) “We met about one year ago” and “I think we met at the pool before” into a group GP2. The information processor 100A classifies two QAC triples identified by the combination information IDs “001-004” and “001-005” into the group GP2 corresponding to a “group providing notification of meeting before”.

In addition, as illustrated in FIG. 22, the information processor 100A classifies QAC triples with the second information (A) “Hmm I'm not sure” and “I don't know” into the group GP3. The information processor 100A classifies two QAC triples identified by the combination information IDs “001-006” and “001-007” into the group GP3 corresponding to a “group providing notification of being not clear”.

Furthermore, as illustrated in FIG. 22, the information processor 100A classifies a QAC triple with the second information (A) “Do you know me?” into the group GP4. The information processor 100A classifies one QAC triple identified by the combination information ID “001-008” into the group GP4 corresponding to “other group”.

As described above, the information processor 100A classifies the eight QAC triples identified by the combination information IDs “001-001” to “001-008” stored in the combination information storage unit 122B in FIG. 22 into the four groups GP1 to GP4.

Furthermore, the information processor 100A uses the information indicating the classification as conditional branching in the conversation scenario. The information processor 100A generates information indicating the branch scenario JS1. For example, the information processor 100A groups the second information (user's answer) and creates a branch of the conversation scenario on the basis of the groups obtained.

Note that, when grouping the second information (user's answer), the information processor 100A may present a plurality of candidates to the user and prompt the user to select a classification method to be used as the scenario branch. In this manner, the information processor 100A may classify the second information (user's answer) in various patterns other than the patterns to classify into the four groups GP1 to GP4. For example, the information processor 100A may classify the second information (user's answer) into two groups in which the groups GP1, GP2, and GP3 are classified as one group (group GP21) that gives some kind of answer and group GP4 is classified as a group returning a question (group GP22).

Furthermore, the information processor 100A may present to the user two patterns that are a pattern (first pattern) to classify into the four groups GP1 to GP4 and a pattern (second pattern) to classify into the two groups GP21 and GP22, and let the user select classification. For example, the information processor 100A may transmit information indicating the first pattern and information indicating the second pattern to the terminal device 10 used by the user. The terminal device 10 may display the received information indicating the first pattern and the received information indicating the second pattern to let the user select which of the first pattern and the second pattern to use. Then, the terminal device 10 may transmit information indicating the pattern selected by the user to the information processor 100A.

Furthermore, in the example in FIG. 23, the information processor 100A selects the character's comment (C) that is the third information corresponding to each of the groups GP1 to GP4. The information processor 100A selects a comment RS1 “Is that so” as the character's comment (C) that is the third information corresponding to the group GP1. The information processor 100A selects the third information “Is that so” having the combination information ID “001-003” corresponding to the group GP1 as the comment RS1, which is the character's comment (C) of the third information corresponding to the group GP1.

The information processor 100A selects a comment RS2 “That's it!” as the character's comment (C) that is the third information corresponding to the group GP2. As the character's comment (C) that is the third information corresponding to the group GP2, the information processor 100A selects the third information “That's it!” with the combination information ID “001-004” corresponding to the group GP2 for the comment RS2.

The information processor 100A selects a comment RS3 “You don't know” as the character's comment (C) that is the third information corresponding to the group GP3. As the character's comment (C) that is the third information corresponding to the group GP3, the information processor 100A selects the third information “You don't know” with the combination information ID “001-007” corresponding to the group GP3 for the comment RS3.

The information processor 100A selects a comment RS4 without words, i.e., no comment, as the character's comment (C) that is the third information corresponding to the group GP4. As the character's comment (C) that is the third information corresponding to the group GP4, the information processor 100A selects no words as the comment RS4 instead of the third information “Yes, I think so” with the combination information ID “001-008” corresponding to the group GP4.

Note that the determination of the above comments is an example, and the information processor 100A may randomly select the character's comment (C) to be used in the scenario from the third information (C) belonging to the group. Furthermore, the information processor 100A may determine the character's comment (C) to be used in the scenario by using an algorithm such as important sentence extraction. For example, the information processor 100A may extract a keyword from the third information (C) belonging to the group using the algorithm such as important sentence extraction, and generate the character's comment (C) using the extracted keyword.

### 1-11. Procedure of Information Processing According to Modification

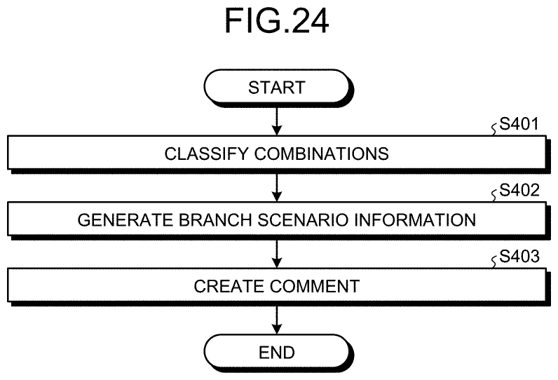

Next, a procedure of information processing according to the modification will be described with reference to FIG. 24. FIG. 24 is a flowchart illustrating a procedure of interactive processing according to the modification.

As illustrated in FIG. 24, the information processor 100A classifies the combinations (Step S401). The information processor 100A groups the user's answers (A) as the second information. The information processor 100A also classifies the character's comments (C) associated with the user's answers (A). In other words, the information processor 100A groups QAC triples on the basis of the user's answers (A) that are the second information.

The information processor 100A generates branch scenario information (Step S402). The information processor 100A creates a branch of the conversation scenario on the basis of the group information obtained.

The information processor 100A creates a comment (Step S403). The information processor 100A selects the character's comment (C) for each branch (group) of the conversation scenario.

### 1-12. Example of Use of Interaction System

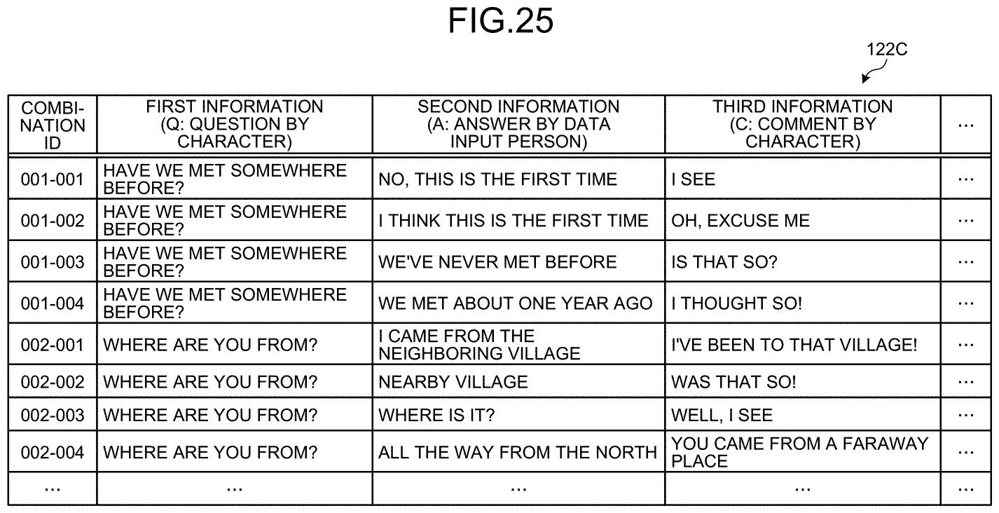

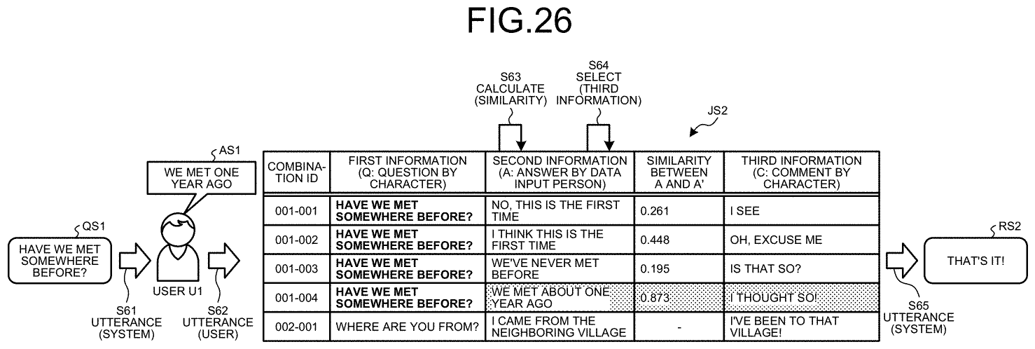

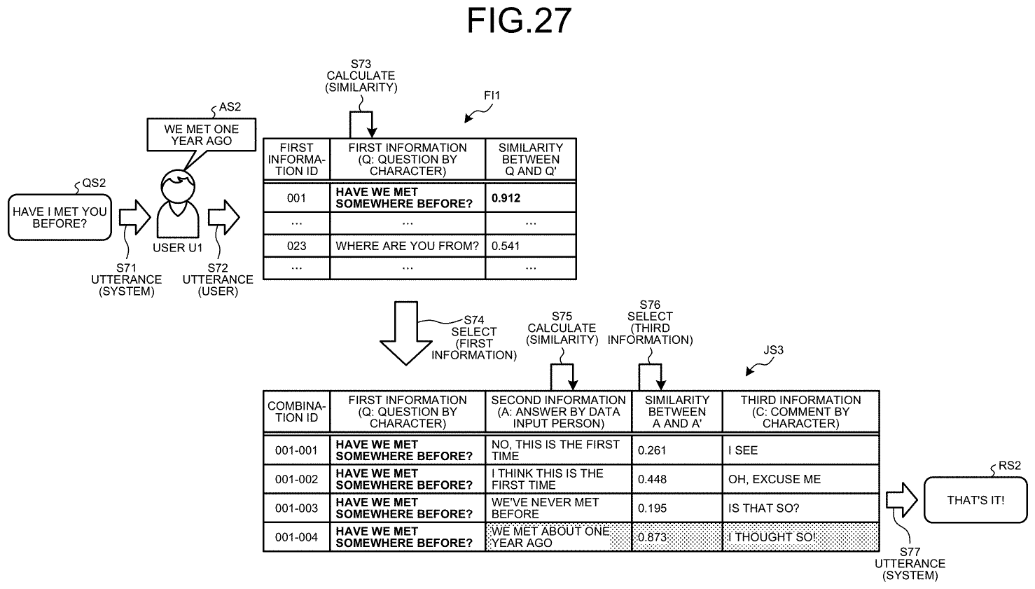

Note that the information processor 100A is not limited to the above, and the information processor 100A may generate various branch scenarios and construct the interaction system using the generated branch scenarios. For example, the information processor 100A may construct the interaction system without using information indicating a group. This point will be described with reference to FIG. 25 to FIG. 27. FIG. 25 is a diagram illustrating another example of the combination information storage unit. FIG. 26 is a diagram illustrating an example of use of the interaction system. FIG. 27 is a diagram illustrating another example of use of the interaction system. Hereinafter, an example of the interaction system using the information stored in a combination information storage unit 122C illustrated in FIG. 25 will be described.

Similarly to the combination information storage unit 122 illustrated in FIG. 5, the combination information storage unit 122C stores the combinations (QAC triples) of the first information (question), the second information (answer), and the third information (response) in association with information for classifying each of the combinations (QAC triples). The combination information storage unit 122C is different from the combination information storage unit 122 illustrated in FIG. 5 in terms of stored information.

In the example in FIG. 25, the combinations (QAC triples) identified by the combination IDs “001-001” to “001-004” correspond to a QAC triple group in which the first information is “Have we met somewhere before?”. For example, the combination (QAC triple) identified by the combination ID “001-004” indicates that the second information is “We met about one year ago” and the third information is “That's it!”.

The combinations (QAC triples) identified by the combination IDs “002-001” to “002-004” correspond to the QAC triple group in which the first information is “Where are you from?”. For example, the combination (QAC triple) identified by the combination ID “002-001” indicates that the second information is “I came from the neighboring village” and the third information is “I've been to that village!”.

Note that the above is an example, and the combination information storage unit 122C is not limited to the above, and may store various types of information depending on the purpose.

Next, an example of using the interaction system using the information stored in the combination information storage unit 122C illustrated in FIG. 25 will be described with reference to FIG. 26. In the example illustrated in FIG. 24 and the like, the information processor 100A classifies a plurality of QAC triples associated with the same first information (Q) according to the content of the second information (A), and uses the classification result. On the other hand, in the example illustrated in FIG. 26, the information processor 100A handles the QAC combination information itself as the conversation data and uses the QAC combination information itself for constructing the interaction system.

The example in FIG. 26 illustrates a case where the system utters a question (Q′) present in the collected QAC triples and the user utters an answer (A′) to the question. In this case, the information processing system 1 calculates an answer (A*) having the highest similarity with the user's answer (A′) from an answer (A) group collected in association with the question (Q′), and outputs a comment (C) associated with the answer (A*) as a system utterance (C′). Note that the similarity between the answer (A) and the answer (A′) may be based on various types of information such as distributed expression. Furthermore, the similarity between the answer (A) and the answer (A′) may have a plurality of similarities, and may be selectively used or combined depending on the application.

In the example in FIG. 26, the information processing system 1 utters a question QS1 “Have we met somewhere before?” (Step S61). For example, the terminal device 10 used by the user U1 utters the question QS1 “Have we met somewhere before?”. The information processor 100A transmits information indicating the question QS1 “Have we met somewhere before?” to the terminal device 10, and the terminal device 10 receiving the information from the information processor 100A utters the question QS1 “Have we met somewhere before?”.

Then, the user U1 utters an answer AS1 “We met one year ago” (Step S62). For example, the terminal device 10 used by the user U1 detects the answer AS1 by the user U1 such as “We met one year ago”, and transmits the detected information to the information processor 100A.

The information processing system 1 calculates the similarity between each answer in the answer group corresponding to the question QS1 “Have we met somewhere before?” and the answer AS1 by the user U1 (Step S63). As illustrated in a branch scenario JS2, the information processing system 1 calculates the similarity between each answer in the answer group corresponding to the question QS1 “Have we met somewhere before?” and the answer AS1 by the user U1.

In the example in FIG. 26, the information processor 100A specifies a QAC triple including the first information corresponding to the question QS1 “Have we met somewhere before?” among the QAC triples in the combination information storage unit 122C illustrated in FIG. 25. The information processor 100A specifies the combination (QAC triple) identified by the combination IDs “001-001” to “001-004” as the QAC triples including the first information corresponding to the question QS1 “Have we met somewhere before?”.

The information processor 100A calculates the similarity between each piece of the second information in the combinations (QAC triples) identified by the combination IDs “001-001” to “001-004” whose first information is “Have we met somewhere before?” and the answer AS1 by the user U1. For example, the information processor 100A calculates the similarity between the second information “We met about one year ago” in the combination (QAC triple) identified by the combination ID “001-004” and the answer AS1 “We met one year ago” as “0.873”.

The information processing system 1 selects a comment on the answer AS1 by the user U1 on the basis of the calculated similarity (Step S64). In the example in FIG. 26, the information processor 100A selects, as a comment to the user U1, the third information “That's it!” having the maximum similarity in the QAC triples corresponding to the second information “We met about one year ago”.

Then, the information processing system 1 utters the selected comment RS2 “That's it!” (Step S65). For example, the terminal device 10 used by the user U1 utters the comment RS2 “That's it!”. The information processor 100A transmits information indicating the comment RS2 “That's it!” to the terminal device 10, and the terminal device 10 that has received the information from the information processor 100A utters the comment RS2 “That's it!”.

Next, another example of the interaction system using the information stored in the combination information storage unit 122C illustrated in FIG. 25 will be described with reference to FIG. 27. Note that description of points similar to those in FIG. 26 will be omitted as appropriate.

The example in FIG. 27 illustrates a case where the system utters a set question (Q′) regardless of collected questions (Q), and the user utters an answer (A′) to the question (Q′). As described above, the example in FIG. 27 illustrates the case where the system utters the set question (Q′) regardless of the questions (Q) in the QAC triples stored in the combination information storage unit 122 illustrated in FIG. 25, and the user utters the answer (A′) to the question (Q′). In this case, the information processing system 1 calculates a question (Q*) having the highest similarity with the question (Q′) in a collected question (Q) group. Then, the information processing system 1 calculates an answer (A*) having the highest similarity with the answer (A′) by the user in the answer (A) group associated with the questions (Q*), and outputs a comment (C) associated with the answer (A*) as a system utterance (C′).

In the example in FIG. 27, the information processing system 1 utters a question QS2 “Have we met before?” (Step S71). For example, the terminal device 10 used by the user U1 utters the question QS2 “Have we met before?”. The information processor 100A transmits information indicating the question QS2 “Have we met before?” to the terminal device 10, and the terminal device 10 that has received the information from the information processor 100A utters the question QS2 “Have we met before?”.

Then, the user U1 utters an answer AS2 “We met one year ago” (Step S72). For example, the terminal device 10 used by the user U1 detects the answer AS2 by the user U1 “We met one year ago”, and transmits the detected information to the information processor 100A.

The information processing system 1 calculates the similarity between the question QS2 “Have we met before?” and each piece of the first information (question) in the collected question (Q) group (Step S73). As indicated in a first information group FI1, the information processor 100A calculates the similarity between the first information (question) identified by the first information ID “001” and the first information (question) identified by the first information ID “023” and the question QS2 “Have we met before?”.

The information processor 100A calculates the similarity between the first information (question) “Have we met somewhere before?” and the question QS2 “Have we met before?” as “0.912”. For example, the information processor 100A calculates the similarity between the question (Q) and the question QS2 on the basis of various conventional technologies such as distributed expression. The information processor 100A calculates the similarity between the first information (question) “Where are you from?” and the question QS2 “Have we met before?” as “0.541”.

The information processing system 1 selects the first information corresponding to the question QS2 “Have we met before?” based on the calculated similarity (Step S74). In the example in FIG. 27, the information processor 100A selects the first information “Have we met somewhere before?” with the maximum similarity as the first information corresponding to the question QS2 “Have we met before?”.

Then, the information processing system 1 calculates the similarity between each answer in the answer group corresponding to the first information “Have we met somewhere before?” and the answer AS2 by the user U1 (Step S75). As illustrated in a branch scenario JS3, the information processing system 1 calculates the similarity between each answer in the answer group corresponding to the first information “Have we met somewhere before?” and the answer AS2 by the user U1.

The information processor 100A calculates the similarity between each piece of the second information in the combinations (QAC triples) identified by the combination IDs “001-001” to “001-004” having the first information “Have we met somewhere before?” and the answer AS2 by the user U1. For example, the information processor 100A calculates the similarity between the second information “We met about one year ago” in the combination (QAC triple) identified by the combination ID “001-004” and the answer AS2 “We met one year ago” as “0.873”.

The information processing system 1 selects a comment on the answer AS2 by the user U1 on the basis of the calculated similarity (Step S76). In the example in FIG. 27, the information processor 100A selects, as a comment on the user U1, the third information “That's it!” in the QAC triple corresponding to the second information “We met about one year ago” having the maximum similarity.

Then, the information processing system 1 utters the selected comment RS2 “That's it!” (Step S77).

As described above, the information processor 100A can handle the QAC combination information itself as the conversation data without using the classification result obtained by classifying the plurality of QAC triples according to the content of the second information (A), so as to construct the interaction system. In this manner, the information processor 100A can appropriately construct the interaction system by appropriately using various types of information.

### 2. Other Embodiments

The processing according to the above-described embodiment and modification may be performed in various different forms (modifications) other than the above-described embodiment and modification.

### 2.-1. Other Configuration Examples

Note that, in the above examples, the device (information processor 100 or the information processor 100A) that collects the combination of the first information, the second information, and the third information are separate from the device (terminal device 10) used by the user. However, these devices may be integrated. For example, a device (terminal device) used by the user may be an information processor having a function of collecting information and a function of displaying information and accepting an operation by the user.

### 2-2. Others

Among the processes described in each of the above embodiments, all or part of the processes described as being performed automatically can be performed manually, or all or part of the processes described as being performed manually can be performed automatically using a known method. In addition, the processing procedure, specific name, and information including various types of data and parameters illustrated in the above document and the drawings can be arbitrarily changed unless otherwise specified. For example, the various types of information illustrated in each drawing are not limited to the illustrated information.

In addition, each component of each device illustrated in the drawings is functionally conceptual, and is not necessarily physically configured as illustrated in the drawings. In other words, a specific form of distribution and integration of each device is not limited to the illustrated form, and all or a part thereof can be functionally or physically distributed and integrated in an arbitrary unit according to various loads, usage conditions, and the like.

In addition, the above-described embodiments and modifications can be appropriately combined within a scope not contradicting processes.

Furthermore, effects described in the present specification are merely examples and are not limited, and other effects may be provided.

### 3. Advantageous Effects of Present Disclosure

As described above, the information processor (information processors 100 and 100A in the embodiment) according to the present disclosure includes the acquisition unit (acquisition unit 131 in the embodiment) and the collection unit (collection unit 132 in the embodiment). The acquisition unit acquires the first information serving as the trigger for interaction, the second information indicating an answer to the first information, and the third information indicating a response to the second information. The collection unit collects a combination of the first information, the second information, and the third information acquired by the acquisition unit.

As a result, the information processor according to the present disclosure can collect the combination of the first information serving as the trigger for interaction, the second information indicating the answer to the first information, and the third information indicating the response to the second information. Thus, the information for constructing the interaction system can be easily collected. In this manner, the information processor can acquire the information for constructing the interaction system by collecting a combination of three pieces of information that are the information serving as the trigger for interaction, the answer to the information, and the response to the answer. Then, by using the collected information for constructing the interaction system, the information processor can construct the interaction system that performs an appropriate conversation.

In addition, the acquisition unit acquires the first information that is the question, the second information that is the reply to the first information, and the third information that is the reply to the second information. As a result, the information processor can easily collect the combination of three pieces of information that are the question, the reply to the question, and the reply to the reply, and can acquire information for constructing the interaction system.

In addition, the collection unit stores a combination of the first information, the second information, and the third information in the storage unit (storage unit 120 in the embodiment). As a result, the information processor can collect the combination of the first information, the second information, and the third information by storing the combination of the first information, the second information, and the third information in the storage unit, and can acquire the information for constructing the interaction system.

Furthermore, the acquisition unit acquires the first information corresponding to utterance by the first subject, the second information corresponding to utterance by the second subject, and the third information corresponding to utterance by the third subject. As a result, the information processor can easily collect a three-piece combination of the utterance by the first subject, the utterance by the second subject, and the utterance by the third subject, and can acquire information for constructing the interaction system.

Furthermore, the acquisition unit acquires the first information, the second information corresponding to the utterance by the second subject different from the first subject, and the third information corresponding to the utterance by the third subject that is the first subject. As a result, the information processor can easily collect the combination including utterances by a plurality of subjects, and can acquire information for constructing the interaction system.

Furthermore, the acquisition unit acquires the first information corresponding to the utterances by the first subject that is the agent of the interaction system, the second information corresponding to the utterance by the second subject that is the user, and the third information corresponding to the utterance by the third subject that is an agent of the interaction system. As a result, the information processor can easily collect information regarding the interaction between the agent of the interaction system and the user, and can acquire information for constructing the interaction system.

In addition, the acquisition unit acquires the first information, the second information, and the third information in which at least one of the first information, the second information, and the third information is input by the user. As a result, the information processor can acquire the information for constructing the interaction system by easily collecting the combinations including the information input by the user.

In addition, the acquisition unit acquires the first information presented to the input user, the second information input by the input user, and the third information input by the input user. As a result, the information processor presents the first information to the user and prompts the user to input the second information corresponding to the first information and the third information, thereby easily collecting the combination of the first information, the second information, and the third information. Therefore, the information processor can acquire information for constructing the interaction system.

Still more, the acquisition unit acquires the meta information of the input user. The collection unit associates the meta information of the input user acquired by the acquisition unit with a combination of the first information, the second information, and the third information. As a result, the information processor can acquire information for constructing the interaction system. Then, the information processor can construct the interaction system in consideration with the information of the user who has input the information.

Furthermore, the information processor includes the generation unit (generation unit 133 in the embodiment). The acquisition unit acquires a plurality of pieces of unit information that is information of the interaction constituent unit corresponding to the combination of the first information serving as the trigger for interaction, the second information indicating the answer to the first information, and the third information indicating the response to the second information. The generation unit generates the scenario information indicating the flow of interaction on the basis of the plurality of pieces of unit information acquired by the acquisition unit. As a result, the information processor can generate the scenario information indicating an appropriate flow of interaction by using the information such as the first information, the second information, and the third information, and can acquire the information for constructing the interaction system. Then, the information processor can construct the interaction system that performs an appropriate conversation by using the generated information.

The acquisition unit acquires the plurality of pieces of unit information of a constituent unit that is the combination of the first information, the second information, and the third information. The generation unit generates the scenario information including a plurality of combinations by connecting the plurality of combinations. As a result, the information processor can generate the scenario information including the plurality of combinations by connecting the plurality of combinations. Therefore, the information processor can acquire information for constructing the interaction system.

In addition, the acquisition unit acquires designation information on the way of connecting the combinations by the user to which a plurality of pieces of unit information is presented. The generation unit generates the scenario information on the basis of the designation information designated by the user. As a result, the information processor can acquire the information for constructing the interaction system by generating the scenario information by using the way of connecting the combinations designated by the user.

The acquisition unit acquires the connection information that is the information on connection of the combinations of the first information, the second information, and the third information. The generation unit generates the scenario information in which the connection information is arranged between the combination pieces to be connected. As a result, the information processor can generate the scenario information with an appropriate logical relationship by generating the scenario information in which the connective word such as a conjunction is arranged between the combinations. Therefore, the information processor can acquire information for constructing the interaction system.

The acquisition unit acquires the connection information designated by the user. The generation unit generates the scenario information on the basis of the connection information designated by the user. As a result, the information processor can acquire the information for constructing the interaction system by generating the scenario information using the conjunction or the like designated by the user.

In addition, the acquisition unit acquires the plurality of pieces of unit information of the constituent unit that are the first information, the second information, and the third information. The generation unit associates a plurality of pieces of the second information corresponding to one piece of the first information or a plurality of second groups obtained by classifying a plurality of pieces of the second information with one piece of the first information, thereby generating the scenario information including a branch from the one piece of first information. As a result, the information processor can generate the scenario information having a plurality of branches from one piece of first information, and can acquire information for constructing the interaction system. Then, the information processor can construct the interaction system that performs an appropriate conversation by using the generated information.

Furthermore, the information processor includes the creation unit (creation unit 138 in the embodiment). The creation unit creates a comment to be presented to the user on the basis of the answer by the user to whom the one piece of first information is presented and the scenario information. As a result, the information processor can create the comment to be presented to the user on the basis of the answer by the user to whom the one piece of first information is presented and the scenario information, thereby making an appropriate comment to the user.

In addition, the generation unit stores the generated scenario information in the storage unit. As a result, the information processor can acquire the information for constructing the interaction system by storing the scenario information in the storage unit. Then, the information processor can use the scenario information for constructing the interaction system, and can construct the interaction system that performs an appropriate conversation.

Furthermore, the information processor includes the learning unit (creation unit 135 in the embodiment). The learning unit learns the model related to automatic generation of the scenario information on the basis of information related to the scenario information generated by the generation unit. As a result, the information processor can generate information for constructing the interaction system by using the learned model, and can acquire the information for constructing the interaction system. Then, the information processor can construct the interaction system that performs an appropriate conversation by using the generated information.

### 4. Hardware Configuration

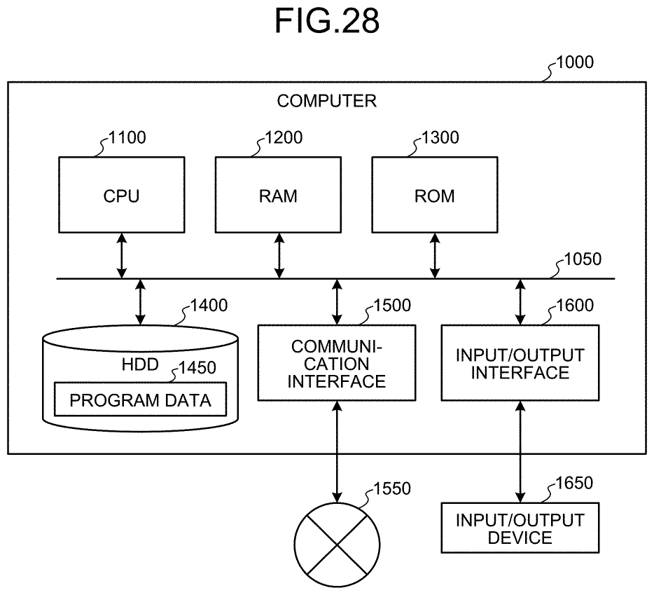

Information devices such as the information processor 100 or 100A and the terminal device 10 according to the above-described embodiment and modifications are realized, for example, by a computer 1000 having a configuration as illustrated in FIG. 28. FIG. 28 is a hardware configuration diagram illustrating an example of the computer 1000 that realizes the functions of the information processors such as the information processor 100 or 100A and the terminal device 10. Hereinafter, the information processor 100 according to the embodiment will be described as an example. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-transiently records a program executed by the CPU 1100, data used by the program, and the like. Specifically, the HDD 1400 is a recording medium that records an information processing program according to the present disclosure, which is an example of program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard or a mouse via the input/output interface 1600. In addition, the CPU 1100 transmits data to an output device such as a display, a loudspeaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, or a semiconductor memory. For example, in a case where the computer 1000 functions as the information processor 100 according to the embodiment, the CPU 1100 of the computer 1000 realizes the functions of the control unit 130 and the like by executing the information processing program loaded on the RAM 1200. In addition, the HDD 1400 stores the information processing program according to the present disclosure and data in the storage unit 120. Note that the CPU 1100 reads the program data 1450 from the HDD 1400 and executes the program data, but as another example, these programs may be acquired from another device via the external network 1550.

Note that the present technology can also have the following configurations.
(1)

An information processor comprising:

an acquisition unit that acquires first information serving as a trigger for interaction, second information indicating an answer to the first information, and third information indicating a response to the second information; and

a collection unit that collects a combination of the first information, the second information, and the third information acquired by the acquisition unit.
(2)

The information processor according to (1), wherein

the acquisition unit acquires the first information that is a question, the second information that is a reply to the first information, and the third information that is a reply to the second information.
(3)

The information processor according to (1) or (2), wherein

the collection unit stores the combination of the first information, the second information, and the third information in a storage unit.
(4)

The information processor according to any one of (1) to (3), wherein

the acquisition unit acquires the first information corresponding to an utterance by a first subject, the second information corresponding to an utterance by a second subject, and the third information corresponding to an utterance by a third subject.
(5)

The information processor according to (4), wherein

the acquisition unit acquires the first information, the second information corresponding to the utterance by the second subject different from the first subject, and the third information corresponding to the utterance by the third subject that is the first subject.
(6)

The information processor according to (4) or (5), wherein

the acquisition unit acquires the first information corresponding to the utterance by the first subject that is an agent of an interaction system, the second information corresponding to the utterance by the second subject that is a user, and the third information corresponding to the utterance by the third subject that is the agent of the interaction system.
(7)

The information processor according to any one of (1) to (6), wherein

the acquisition unit acquires the first information, the second information, and the third information, at least one of the first information, the second information, and the third information being input by a user.
(8)

The information processor according to any one of (1) to (7), wherein

the acquisition unit acquires the first information presented to an input user, the second information input by the input user, and the third information input by the input user.
(9)

The information processor according to (8), wherein

the acquisition unit acquires meta information of the input user, and

the collection unit associates the meta information of the input user acquired by the acquisition unit with the combination of the first information, the second information, and the third information.
(10)

An information processing method comprising:

acquiring first information serving as a trigger for interaction, second information indicating an answer to the first information, and third information indicating a response to the second information; and

collecting a combination of the first information, the second information, and the third information.
(11)

An information processor comprising:

an acquisition unit that acquires a plurality of pieces of unit information that is information of a constituent unit of interaction corresponding to a combination of first information serving as a trigger for the interaction, second information indicating an answer to the first information, and third information indicating a response to the second information; and

a generation unit that generates scenario information indicating a flow of the interaction based on the plurality of pieces of the unit information acquired by the acquisition unit.
(12)

The information processor according to (11), wherein

the acquisition unit acquires the plurality of pieces of the unit information of the constituent unit that is the combination of the first information, the second information, and the third information, and

the generation unit connects a plurality of the combinations to generate the scenario information including the plurality of combinations.
(13)

The information processor according to (12), wherein

the acquisition unit acquires designation information designated by a user to whom the plurality of pieces of the unit information is presented, the designation information indicating a way of connecting the plurality of combinations, and

the generation unit generates the scenario information based on the designation information designated by the user.
(14)

The information processor according to (12) or (13), wherein

the acquisition unit acquires connection information that is information on connection of the plurality of combinations, each of the plurality of combinations including the first information, the second information, and the third information, and

the generation unit generates the scenario information in which the connection information is arranged between the plurality of combinations to be connected.
(15)

The information processor according to (14), wherein

the acquisition unit acquires the connection information designated by a user, and

the generation unit generates the scenario information based on the connection information designated by the user.
(16)

The information processor according to (11), wherein

the acquisition unit acquires the plurality of pieces of the unit information of the constituent unit that is each of the first information, the second information, and the third information, and

the generation unit generates the scenario information including a branch from one piece of the first information by associating the one piece of the first information with a plurality of pieces of the second information corresponding to the one piece of the first information or a plurality of second groups into which the plurality of pieces of the second information is classified.
(17)

The information processor according to (16), further comprising a creation unit that creates a comment to be presented to a user based on an answer by the user to whom the one piece of the first information is presented and the scenario information.
(18)

The information processor according to any one of (11) to (17), wherein

the generation unit stores the scenario information generated in a storage unit.
(19)

The information processor according to any one of (11) to (18), further comprising a learning unit that learns a model related to automatic generation of the scenario information based on information related to the scenario information generated by the generation unit.
(20)

An information processing method comprising:

acquiring a plurality of pieces of unit information that is information of a constituent unit of interaction corresponding to a combination of first information serving as a trigger for the interaction, second information indicating an answer to the first information, and third information indicating a response to the second information; and

generating scenario information indicating a flow of the interaction based on the plurality of pieces of the unit information.

### REFERENCE SIGNS LIST

1 INFORMATION PROCESSING SYSTEM
100, 100A INFORMATION PROCESSOR
110 COMMUNICATION UNIT
120, 120A STORAGE UNIT
121 FIRST INFORMATION STORAGE UNIT
122 COMBINATION INFORMATION STORAGE UNIT
123 CONNECTION INFORMATION STORAGE UNIT
124, 126 SCENARIO INFORMATION STORAGE UNIT
125 MODEL INFORMATION STORAGE UNIT
130, 130A CONTROL UNIT
131 ACQUISITION UNIT
132 COLLECTION UNIT
133 CALCULATION UNIT
134 DETERMINATION UNIT
135 LEARNING UNIT
136 TRANSMISSION UNIT
137 CLASSIFICATION UNIT
138 CREATION UNIT
10 TERMINAL DEVICE
11 COMMUNICATION UNIT
12 INPUT UNIT
13 OUTPUT UNIT
14 STORAGE UNIT
15 CONTROL UNIT
151 RECEPTION UNIT
152 DISPLAY CONTROL UNIT
153 ACCEPTANCE UNIT
154 TRANSMISSION UNIT
16 DISPLAY UNIT

1. An information processor comprising:
an acquisition unit that acquires first information serving as a trigger for interaction, second information indicating an answer to the first information, and third information indicating a response to the second information; and
a collection unit that collects a combination of the first information, the second information, and the third information acquired by the acquisition unit.

2. The information processor according to claim 1, wherein
the acquisition unit acquires the first information that is a question, the second information that is a reply to the first information, and the third information that is a reply to the second information.

3. The information processor according to claim 1, wherein
the collection unit stores the combination of the first information, the second information, and the third information in a storage unit.

4. The information processor according to claim 1, wherein
the acquisition unit acquires the first information corresponding to an utterance by a first subject, the second information corresponding to an utterance by a second subject, and the third information corresponding to an utterance by a third subject.

5. The information processor according to claim 4, wherein
the acquisition unit acquires the first information, the second information corresponding to the utterance by the second subject different from the first subject, and the third information corresponding to the utterance by the third subject that is the first subject.

6. The information processor according to claim 4, wherein
the acquisition unit acquires the first information corresponding to the utterance by the first subject that is an agent of an interaction system, the second information corresponding to the utterance by the second subject that is a user, and the third information corresponding to the utterance by the third subject that is the agent of the interaction system.

7. The information processor according to claim 1, wherein
the acquisition unit acquires the first information, the second information, and the third information, at least one of the first information, the second information, and the third information being input by a user.

8. The information processor according to claim 1, wherein
the acquisition unit acquires the first information presented to an input user, the second information input by the input user, and the third information input by the input user.

9. The information processor according to claim 8, wherein
the acquisition unit acquires meta information of the input user, and
the collection unit associates the meta information of the input user acquired by the acquisition unit with the combination of the first information, the second information, and the third information.

10. An information processing method comprising:
acquiring first information serving as a trigger for interaction, second information indicating an answer to the first information, and third information indicating a response to the second information; and
collecting a combination of the first information, the second information, and the third information.

11. An information processor comprising:
an acquisition unit that acquires a plurality of pieces of unit information that is information of a constituent unit of interaction corresponding to a combination of first information serving as a trigger for the interaction, second information indicating an answer to the first information, and third information indicating a response to the second information; and
a generation unit that generates scenario information indicating a flow of the interaction based on the plurality of pieces of the unit information acquired by the acquisition unit.

12. The information processor according to claim 11, wherein
the acquisition unit acquires the plurality of pieces of the unit information of the constituent unit that is the combination of the first information, the second information, and the third information, and
the generation unit connects a plurality of the combinations to generate the scenario information including the plurality of combinations.

13. The information processor according to claim 12, wherein
the acquisition unit acquires designation information designated by a user to whom the plurality of pieces of the unit information is presented, the designation information indicating a way of connecting the plurality of combinations, and
the generation unit generates the scenario information based on the designation information designated by the user.

14. The information processor according to claim 12, wherein
the acquisition unit acquires connection information that is information on connection of the plurality of combinations, each of the plurality of combinations including the first information, the second information, and the third information, and
the generation unit generates the scenario information in which the connection information is arranged between the plurality of combinations to be connected.

15. The information processor according to claim 14, wherein
the acquisition unit acquires the connection information designated by a user, and
the generation unit generates the scenario information based on the connection information designated by the user.

16. The information processor according to claim 11, wherein
the acquisition unit acquires the plurality of pieces of the unit information of the constituent unit that is each of the first information, the second information, and the third information, and
the generation unit generates the scenario information including a branch from one piece of the first information by associating the one piece of the first information with a plurality of pieces of the second information corresponding to the one piece of the first information or a plurality of second groups into which the plurality of pieces of the second information is classified.

17. The information processor according to claim 16, further comprising a creation unit that creates a comment to be presented to a user based on an answer by the user to whom the one piece of the first information is presented and the scenario information.

18. The information processor according to claim 11, wherein
the generation unit stores the scenario information generated in a storage unit.

19. The information processor according to claim 11, further comprising a learning unit that learns a model related to automatic generation of the scenario information based on information related to the scenario information generated by the generation unit.

20. An information processing method comprising:
acquiring a plurality of pieces of unit information that is information of a constituent unit of interaction corresponding to a combination of first information serving as a trigger for the interaction, second information indicating an answer to the first information, and third information indicating a response to the second information; and
generating scenario information indicating a flow of the interaction based on the plurality of pieces of the unit information.
